(19) United States
(12) Patent Application Publication
(10) Pub. No.: US 2015/0030252 A1
(43) Pub. Date: Jan. 29, 2015

(54) METHODS OF RECOGNIZING ACTIVITY IN VIDEO

(71) Applicant: The Research Foundation for The State University of New York, Amherst, NY (US)

(72) Inventors: Jason J. Corso, Buffalo, NY (US); Sreemanananth Sadanand, Buffalo, NY (US)

(73) Assignee: The Research Foundation for The State University of New York, Amherst, NY (US)

(21) Appl. No.: 14/365,513

(22) PCT Filed: Dec. 17, 2012
(86) PCT No.: PCT/US2012/070211

§ 371 Date: Jun. 13, 2014

Related U.S. Application Data
(60) Provisional application No. 61/576,648, filed on Dec. 16, 2011.

(51) Int. Cl. G06K 9/62; G06K 9/00

(52) U.S. Cl. CPC G06K 9/6202; G06K 9/00744
USPC 382/197

(57) ABSTRACT

The present invention is a method for carrying out high-level activity recognition on a wide variety of videos. In one embodiment, the invention leverages the fact that a large number of smaller action detectors, when pooled appropriately, can provide high-level semantically rich features that are superior to low-level features in discriminating videos. Another embodiment recognizes activity using a bank of template objects corresponding to actions and having template sub-vectors. The video is processed to obtain a featurized video and a corresponding vector is calculated. The vector is correlated with each template object sub-vector to obtain a correlation vector. The correlation vectors are computed into a volume, and maximum values are determined corresponding to one or more actions.

### CROSS-REFERENCE TO RELATED APPLICATIONS

This application claims priority to U.S. Provisional Application No. 61/576,648, filed on Dec. 16, 2011, now pending, the disclosure of which is incorporated herein by reference.

### STATEMENT REGARDING FEDERALLY SPONSORED RESEARCH

This invention was made with government support under grant no. W911NF-10-2-0062 awarded by the Defense Advanced Research Projects Agency. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to methods for activity recognition and detection, name computerized activity recognition and detection in video.

### BACKGROUND OF THE INVENTION

Human motion and activity is extremely complex. Automatically inferring activity from video in a robust manner leading to a rich high-level understanding of video remains a challenge despite the great energy the computer vision community has invested in it. Previous approaches to recognize activity in a video were primarily based on low- and mid-level features such as local space-time features, dense point trajectories, and dense 3D gradient histograms to name a few.

Low- and mid-level features, by nature, carry little semantic meaning. For example, some techniques emphasize classifying whether an action is present or absent in a given video, rather than detecting where and when in the video the action may be happening

Low- and mid-level features are limited in the amount of motion semantics they can capture, which often yields a representation with inadequate discriminative power for larger, more complex datasets. For example, the HOG/HOF method achieves 85.6% accuracy on the smaller 9-class UCF Sports data set but only achieves 47.9% accuracy on the larger 50-class UCF50 dataset. A number of standard datasets exist (including UCF Sports, UCF50, KTH, etc.). These standard datasets comprise a number of videos containing actions to be detected. By using standard datasets, the computer vision community has a baseline to compare action recognition methods

Other methods seeking a more semantically rich and discriminative representation have focused on object and scene semantics or human pose, such as facial detection, which is itself challenging and unsolved. Perhaps the most studied and successful approaches thus far in activity recognition are based on “bag of features” (dense or sparse) models. Sparse space-time interest points and subsequent methods, such as local trinary patterns, dense interest points, page-rank features, and discriminative class-specific features, typically compute a bag of words representation on local features and sometimes local context features that is used for classification. Although promising, these methods are predominantly global recognition methods and are not well suited as individual action detectors.

Other methods rely upon an implicit ability to find and process the human before recognizing the action. For example, some methods develop a space-time shape representation of the human motion from a segmented silhouette. Joint-keyed trajectories and pose-based methods involve localizing and tracking human body parts prior to modeling and performing action recognition. Obviously, this second class of methods is better suited to localizing action, but the challenge of localizing and tracking humans and human pose has limited their adoption.

Therefore existing methods of activity recognition and detection suffer from poor accuracy due to complex datasets, poor discrimination of scene semantics or human pose, and difficulties involved with localizing and tracking humans throughout a video.

### BRIEF SUMMARY OF THE INVENTION

The present invention demonstrates activity recognition for a wide variety of activity categories in realistic video and on a larger scale than the prior art. In tested cases, the present invention outperforms all known methods, and in some cases by a significant margin.

The invention can be described as a method of recognizing activity in a video object. In one embodiment, the method recognizes activity in a video object using an action bank containing a set of template objects. Each template object corresponds to an action and has a template sub-vector. The method comprising the steps of processing the video object to obtain a featurized video object, calculating a vector corresponding to the featurized video object, correlating the featurized video object vector with each template object sub-vector to obtain a correlation vector, computing the correlation vectors into a correlation volume, and determining one or more maximum values corresponding to one or more actions of the action bank to recognize activity in the video object. In one embodiment, the activity is recognized at a time and space within the video object.

In another embodiment, the method further comprises the step of dividing the video object into video segments. In this embodiment, the step of calculating a vector corresponding to the video object is based on the video segments. The sub-vector may also have an energy volume, such as a spatiotemporal energy volume.

In one embodiment, the featurized video object is correlated with each template object sub-vector at multiple scales. In some embodiments, the one or more maximum values are determined at multiple scales. In other embodiments, both the maximum values and template object sub-vector correlation are performed at multiple scales.

In another embodiment, the step of determining one or more maximum values corresponding to the actions of the action bank comprises the sub-step of applying a support vector machine to the one or more maximum values. The video object may have an energy volume (such as a spatiotemporal energy volume), and the method may further comprise the step of correlating the template object sub-vector energy volume to the video object energy volume.

The method may further comprise the step of calculating an energy volume of the video object, the calculation step comprising the sub-steps of calculating a first structure volume corresponding to static elements in the video object, calculating a second structure volume corresponding to a lack of oriented structure in the video object, calculating at least one directional volume of the video object, and subtracting the first structure volume and the second structure volume from the directional volumes.

In one embodiment, the present invention embeds a video into an “action space” spanned by various action detector responses (i.e., correlation/similarity volumes), such as walking-to-the-left, drumming-quickly, etc. The individual action detectors may be template-based detectors (collectively referred to as a “bank”). Each individual action detector correlation video volume is transformed into a response vector by volumetric max-pooling (3-levels for a 73-dimension vector). For example, in one action detector bank, there may be 205 action detector templates in the bank, sampled broadly in semantic and viewpoint space. The action bank representation may be a high-dimensional vector (73 dimensions for each bank template, which are concatenated together) that embeds a video into a semantically rich action-space. Each 73-dimension sub-vector may be a volumetrically max-pooled individual action detection response.

In one embodiment, the method may be implemented through software in two steps. First, software will “featurize” the video. The featurization involves computing a 7-channel decomposition of the video into spatiotemporal oriented energies. For each video, a 7-channel decomposition file is stored. Second, the software will then apply the library to each of the videos, which involves, correlating each channel of the 7-channel decomposed representation via Bhattacharyya matching. In some embodiments, only 5 channels are actually correlated with all bank template videos, summing them to yield a correlation volume, and finally doing 3-level volumetric max-pooling. For each bank template video, this outputs a 73-dimension vector, which are all stacked together over the bank templates (e.g., 205 in one embodiment). For example, when there are 205 bank templates, a single-scale bank embedding is a 14,965 dimension vector.

In order to reduce processing time, some embodiments of the present application may cache all of its computation. On subsequent computations, the method may include a step to checks if a cached version is present before computing it. If a cached version is present, then the data is simply loaded it rather than recomputed.

In one embodiment, the method may traverse an entire directory tree and bank all of the videos in it, replicating them in the output directory tree, which is created to match that of the input directory tree.

In another embodiment, the method may include the step of reducing the input spatial resolution of the input videos.

In one embodiment, the method may include the step of training an SVM classifier and doing k-fold cross-validation. However, the invention is not restricted to SVMs or any specific way that the SVMs are learned.

Template-based action detectors can be added to the bank. In one embodiment, action detectors are simply templates. A new template can easily be added to the bank by extracting a sub-video (manually or programmatically) and featurizing the video.

In another embodiment, the step of classification is performed using SHOGUN (http://www.shogun-toolbox.org/page/about/information). SHOGUN is a machine learning toolbox focused on large scale kernel methods and especially on SVMs.

The method of the present invention may be performed over multiple scales. Some embodiments will only compute the bank feature vector at a single scale. Others compute the bank feature vector at two or more scales. The scales may modify spatial resolution, temporal resolution, or both.

### DESCRIPTION OF THE DRAWINGS

For a fuller understanding of the nature and objects of the invention, reference should be made to the following detailed description taken in conjunction with the accompanying drawings, in which:

FIG. 1 is a diagram of a method of recognizing activity in a video object according to one embodiment of the present invention;

FIG. 2 is a diagram showing visual depictions of various individual action detectors. Faces are redacted for presentation only;

FIG. 3 is a diagram showing the step of volumetric max-pooling according to one embodiment of the present invention;

FIG. 4 is a diagram showing a spatiotemporal orientation energy representation that may be used for the individual action detectors according to one embodiment of the present invention;

FIG. 5 is a diagram showing the relative contribution of the dominant positive and negative bank entries when tested against an input video according to one embodiment of the present invention;

FIG. 6 is a matrix showing the confusion level of an embodiment of the present invention when tested against a known dataset;

FIG. 7 is a matrix showing the confusion level of the same embodiment of the present invention when tested against a known broad dataset;

FIG. 8 is a matrix showing the confusion level of the same embodiment of the present invention when tested against a known, extremely broad dataset;

FIG. 9 is a chart showing the effect of bank size on recognition accuracy as determined in one embodiment of the present invention;

FIG. 10 is a flowchart showing a method of recognizing activity in a video according to one embodiment of the present invention;

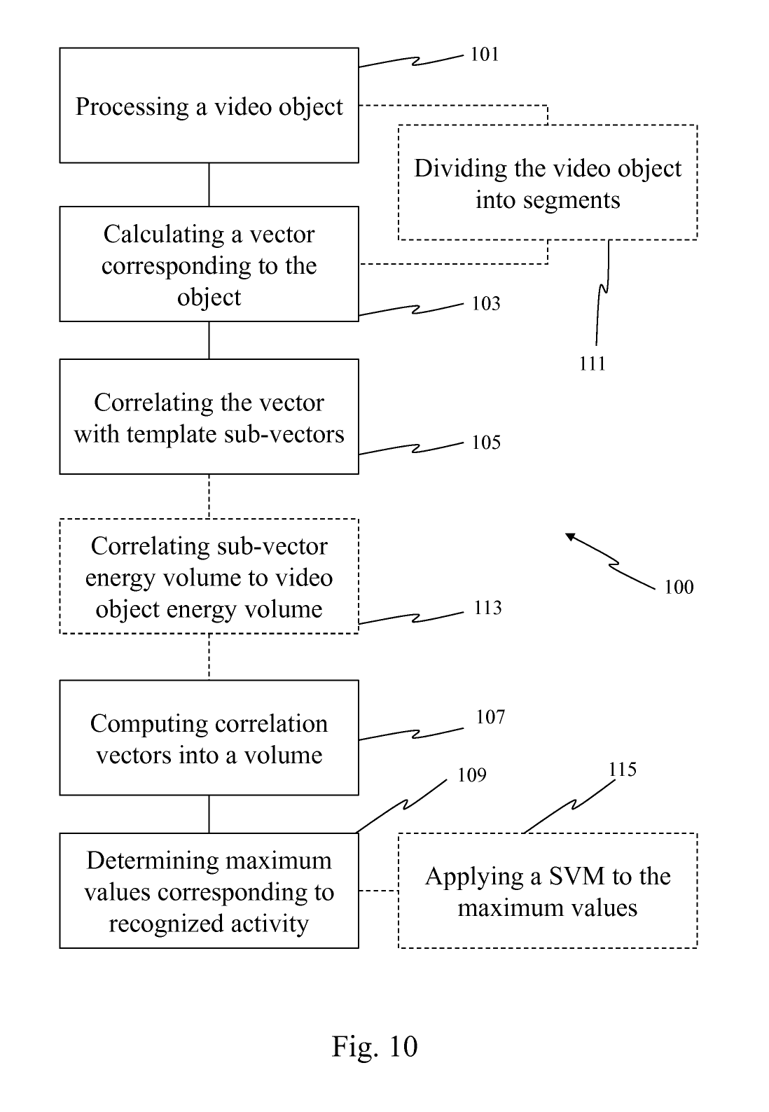

FIG. 11 is a flowchart showing the calculation of an energy volume of the video object according to one embodiment of the present invention;

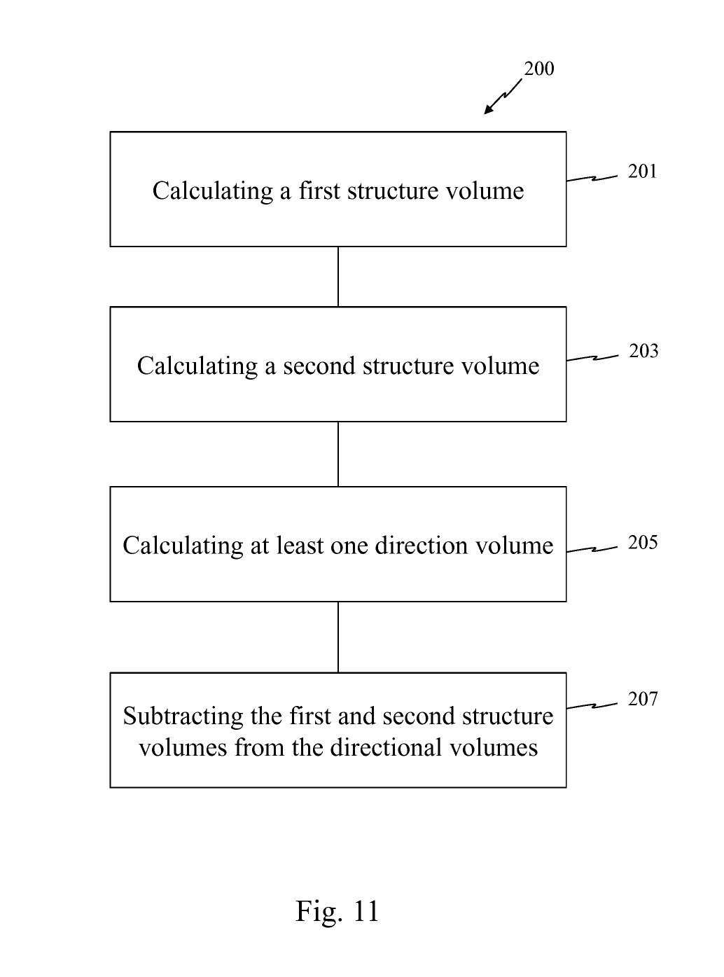

FIG. 12 is a table listing the recognition accuracies of the prior art in comparison to the Action Bank embodiment of the present invention;

FIG. 13 is a table listing the recognition accuracies of the prior art in comparison to the Action Bank embodiment of the present invention on a broader dataset;

FIG. 14 is a table listing the recognition accuracies of the prior art in comparison to the Action Bank embodiment of the present invention on an extremely broad dataset; and

FIG. 15 is a table comparing the overall accuracy of the prior art based on three data sets in comparison to the Action Bank embodiment of the present invention.

### DETAILED DESCRIPTION OF THE INVENTION

The present invention can be described as a method 100 of recognizing activity in a video object using an action bank containing a set of template objects. Activity generally refers to an action taking place in the video object. The activity can be specific (such as a hand moving left-or-right) or more general (such as a parade or a rock band playing at a concert). The method may recognize a single activity or a plurality of activities in the video object. The method may also recognize which activities are not occurring at any given time and place in the video object.

The video object may occur in many forms. The video object may describe a live video feed or a video streamed from a remote device, such as a server. The video object may not be stored in its entirety. Conversely, the video object may be a video file stored on a computer storage medium. For example, the video object may be an audio video interleaved (AVI) video file or an MPEG-4 video file. Other forms of video objects will be apparent to one skilled in the art.

Template objects may also be videos, such as an AVI or MPEG-4 file. The template objects may be modified programmatically to reduce file size or required computation. A template object may be created or stored in such a way that reduces visual fidelity but preserves characteristics that are important for the activity recognition methods of the present invention. Each template object corresponds to an action. For example, a template object may be associated with a label that describes the action occurring in the template object. The template object may be associated with more than one action, which in combination describes a higher-level action.

The template objects have a template sub-vector. The template sub-vector may be a mathematical representation of the activity occurring in the template object. The template sub-vector may also represent only a representation of the associated activity, or the template sub-vector may represent the associated activity in relationship to the other elements in the template object.

The method 100 may comprise the step of processing 101 the video object to obtain a featurized video object. The video object may be processed 101 using a computer processor or any other type of suitable processing equipment. For example, a graphics processing unit (GPU) may be used to accelerate processing 101. Some embodiments of the present invention may use convolution to reduce processing costs. For example, a 2.4 GHz Linux workstation can process a video from UCF50 in 12,210 seconds (204 minutes), on average, with a range of 1,560-121,950 seconds (26-2032 minutes or 0.4-34 hours) and a median of 10,414 seconds (173 minutes). As a basis of comparison, a typical bag of words with HOG3D method ranges between 150-300 seconds, a KLT tracker extracting and tracking sparse points ranges between 240-600 seconds, and a modern optical flow method takes more than 24 hours on the same machine. Another embodiment may be configured to use FFT-based processing.

In one embodiment, actions may be modeled as a composition of energies along spatiotemporal orientations. In another embodiment, actions may be modeled as a conglomeration of motion energies in different spatiotemporal orientations. Motion at a point is captured as a combination of energies along different space-time orientations at that point, when suitably decomposed. These decomposed motion energies are one example of a low-level action representation.

In one embodiment, a spatiotemporal orientation decomposition is realized using broadly tuned 3D Gaussian third derivative filters, G₃_{_{\hat{θ}}}(x), with the unit vector \hat{θ} capturing the 3D direction of the filter symmetry axis and the x denoting space-time position. The responses of the image data to this filter are pointwise squared and summed over a space-time neighbourhood Ω to give a pointwise energy measurement:

$${E}_{\hat{θ}} ( x ) = {\sum }_{x ∈ Ω} {( {G}_{{3}_{\hat{θ}}} * I )}^{2} \qquad ( Eq . 1 )$$

A basis-set of four third-order filters is then computed according to conventional steerable filters:

$${\hat{θ}}_{i} = cos ( \frac{π i}{4} ) {\hat{θ}}_{a} ( \hat{n} ) + sin ( \frac{π i}{4} ) {\hat{θ}}_{b} ( \hat{n} ) , \\ where {\hat{θ}}_{a} ( \hat{n} ) = \frac{\hat{n} \times {\hat{e}}_{x}}{‖ \hat{n} \times {\hat{e}}_{x} ‖} , {\hat{θ}}_{b} ( \hat{n} ) = \hat{n} \times {\hat{θ}}_{a} ( \hat{n} ) \qquad ( Eq . 2 )$$

and ê is the unit vector along the spatial x axis in the Fourier domain and 0≦i≦3. And this basis-set makes it plausible to compute the energy along any frequency domain plane—spatiotemporal orientation—with normal n by a simple sum E_{\hat{n}}(x)=Σᵢ₌₀³E_{\hat{θ}}_{ᵢ}(x) with \hat{θ}(i) as one of the four directions according to Eq. 2.

The featurized video object may be saved as a file on a computer storage medium, or it may be streamed to another device.

The method 100 further comprises the step of calculating 103 a vector corresponding to the featurized video object. The vector may be calculated 103 using a function, such as volumetric max-pooling. The vector may be multidimensional, and will likely be high-dimensional.

The method 100 comprises the step of correlating 105 the featurized video object vector with each template object sub-vector to obtain a correlation vector. In one embodiment, correlation 105 is performed by measuring the similarity of the probability distributions in the video object vector and template object sub-vector. For example, a Bhattacharyya coefficient may be used to approximate measurement of the amount of overlap between the video object vector and template object sub-vector (i.e., the samples). Calculating the Bhattacharyya coefficient involves a rudimentary form of integration of the overlap of the two samples. The interval of the values of the two samples is split into a chosen number of partitions, and the number of members of each sample in each partition is used in the following formula,

$$Bhattacharyya = {\sum }_{i = 1}^{n} \sqrt{( \sum {a}_{i} \cdot \sum {b}_{i} )} \qquad ( Eq . 3 )$$

where considering the samples a and b, n is the number of partitions, and Σaᵢ, Σbᵢ are the number of members of samples a and b in the i'th partition. This formula hence is larger with each partition that has members from both sample, and larger with each partition that has a large overlap of the two sample's members within it. The choice of number of partitions depends on the number of members in each sample; too few partitions will lose accuracy by overestimating the overlap region, and too many partitions will lose accuracy by creating individual partitions with no members despite being in a surroundingly populated sample space.

The Bhattacharyya coefficient will be 0 if there is no overlap at all due to the multiplication by zero in every partition. This means the distance between fully separated samples will not be exposed by this coefficient alone.

The correlation 105 of the featurized video object with each template object sub-vector is performed at multiple scales and the one or more maximum values are determined at multiple scales.

The method 100 comprises the step of computing 107 the correlation vectors into a correlation volume. The step of computation 107 may be as simple as combining the vectors, or may be more computationally expensive.

The method 100 comprises the step of determining 109 one or more maximum values corresponding to one or more actions of the action bank to recognize activity in the video object. The determination 109 step may involve applying a support vector machine to the one or more maximum values.

The method 100 may further comprise the step of dividing 111 the video object into video segments. The segments may be equal in size or length, or they may be of various sizes and lengths. The video segments may overlap one another temporally. In one embodiment, the step of calculating 103 a vector corresponding to the video object is based on the video segments.

In another embodiment of the method 100, the sub-vectors have energy volumes. For example, in one embodiment, seven raw spatiotemporal energies are defined (via different \hat{n}): static Eₛ, leftward Eₗ, rightward Eᵣ, upward Eᵤ, downward E_{d}, flicker E_{f}, and lack of structure Eₒ (which is computed as a function of the other six and peaks when none of the other six have strong energy). These seven energies do not always sufficiently discriminate action from common background. So, the lack of structure Eₒ and static Eₛ, are disassociated with any action and their signals can be used to separate the salient energy from each of the other five energies, yielding a five-dimensional pure orientation energy representation:Eᵢ=Eᵢ−Eₒ−Eₛ, ∀iε{f, l, r, u, d}. The five pure energies may be normalized such that the energy at each voxel over the five channels sums to one. Energy volumes may be calculated by calculating 201 a first structure volume corresponding to static elements in the video object; calculating 203 a second structure volume corresponding to a lack of oriented structure in the video object; calculating 305 at least one directional volume of the video object; and subtracting 207 the first structure volume and the second structure volume from the directional volumes. The video object may also have an energy volume, and the method 100 may further comprise the step of correlating 113 the template object sub-vector energy volume to the video object energy volume.

One embodiment of the present invention can be described as a high-level activity recognition method referred to as “Action Bank.” Action Bank is comprised of many individual action detectors sampled broadly in semantic space as well as viewpoint space. There is a great deal of flexibility in choosing what kinds of action detectors are used. In some embodiments, different types of action detectors can be used concurrently.

The present invention is a powerful method for carrying out high-level activity recognition on a wide variety of realistic videos “in the wild.” This high-level representation has rich applicability in a wide-variety of video understanding problems. In one embodiment, the invention leverages the fact that a large number of smaller action detectors, when pooled appropriately, can provide high-level semantically rich features that are superior to low-level features in discriminating videos—the results shows a significant improvement on every major benchmark, including 76.4% accuracy on the full UCF50 dataset when baseline low-level features yield 47.9%. Furthermore, the present invention also transfers the semantics of the individual action detectors through to the final classifier.

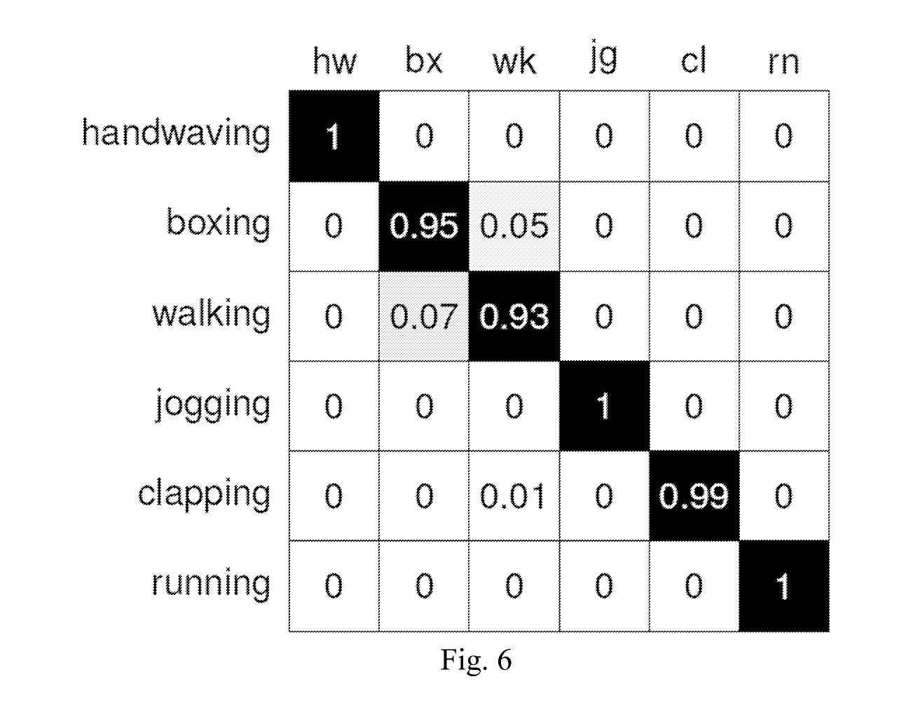

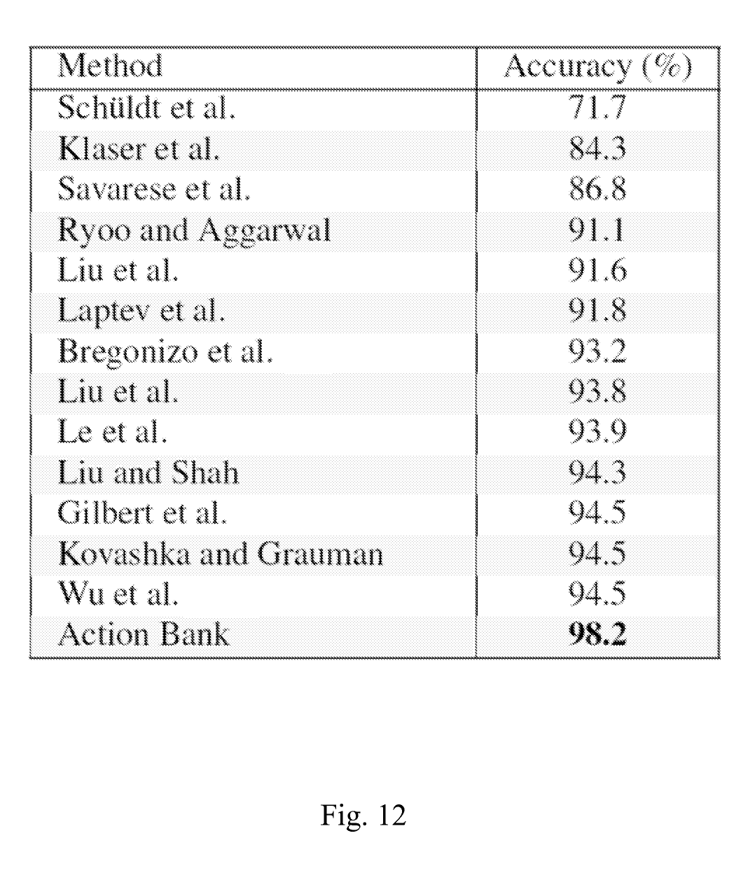

For example, the performance of one embodiment of the present invention was tested on the two standard action recognition benchmarks: KTH and UCFSports. In these experiments, we run the action bank at two scales. On KTH (FIG. 12 and FIG. 6), a leave-one-out cross-validation strategy is used. The tested embodiment scored at 97.8% and outperforms all other methods, three of which share the current best performance of 94.5%. Most of the previous methods reporting high scores are based on feature points and hence have quite a distinct character from the present invention. The present invention outperforms the previous methods by learning classes of actions that the previous methods often confuse. For example, one embodiment of the present invention perfectly learns jogging and running—an area that previous methods found challenging.

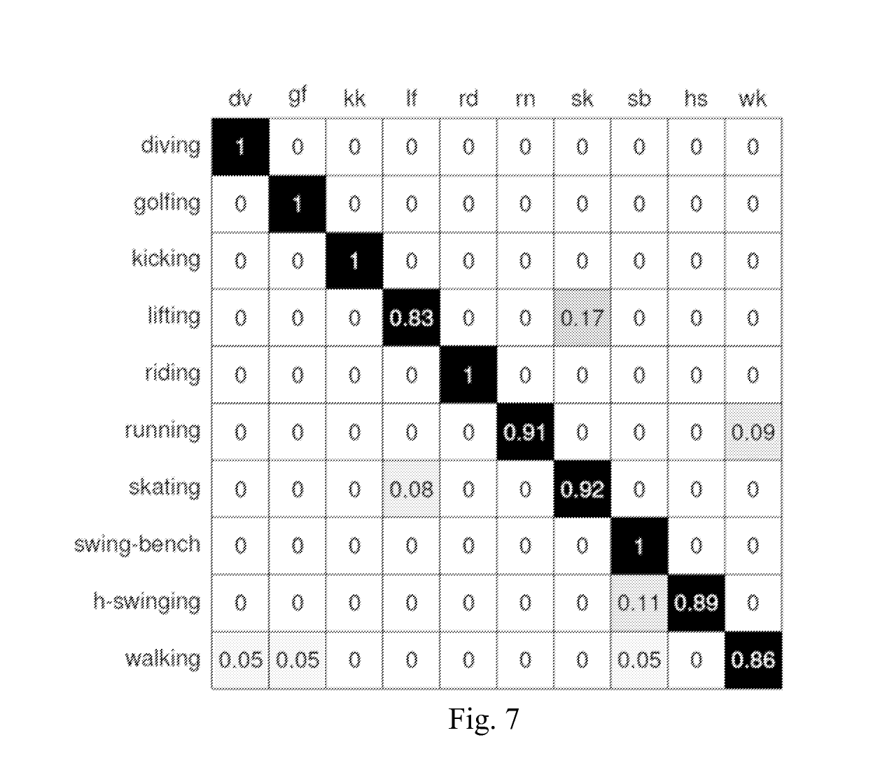

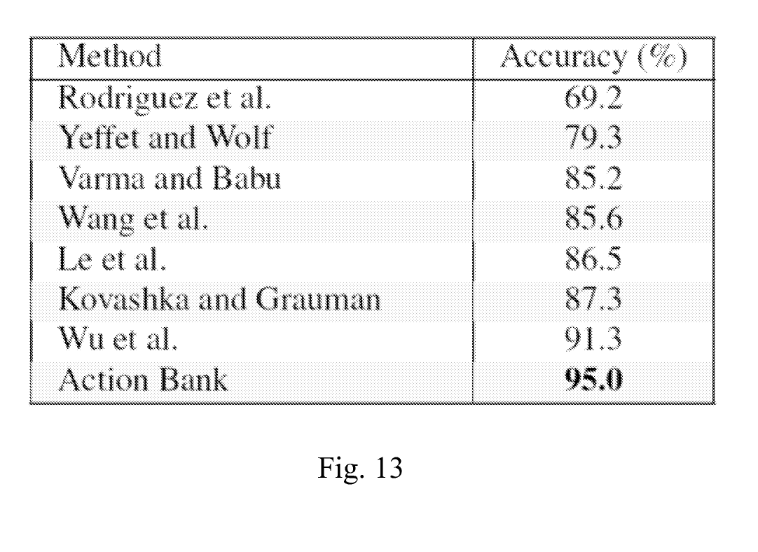

A similar leave-one-out cross-validation strategy is used for UCF Sports, but the strategy does not engage in horizontal flipping of the data. Again, the performance of one embodiment of the invention is at 95% accuracy which is better than all contemporary methods, who achieve at best 91.3% (FIG. 13, FIG. 7).

These two sets of results demonstrate that the present invention is a notable new representation for human activity in video and capable to robust recognition in realistic settings. However, these two benchmarks are small. One embodiment of the present invention was tested against a much more realistic benchmark which is an order of magnitude larger in terms of classes and number of videos.

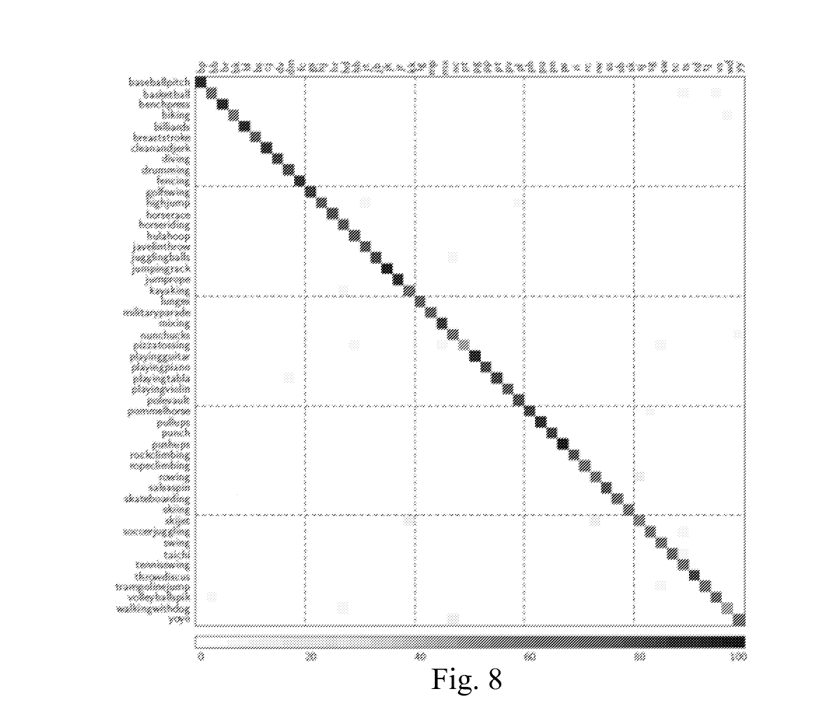

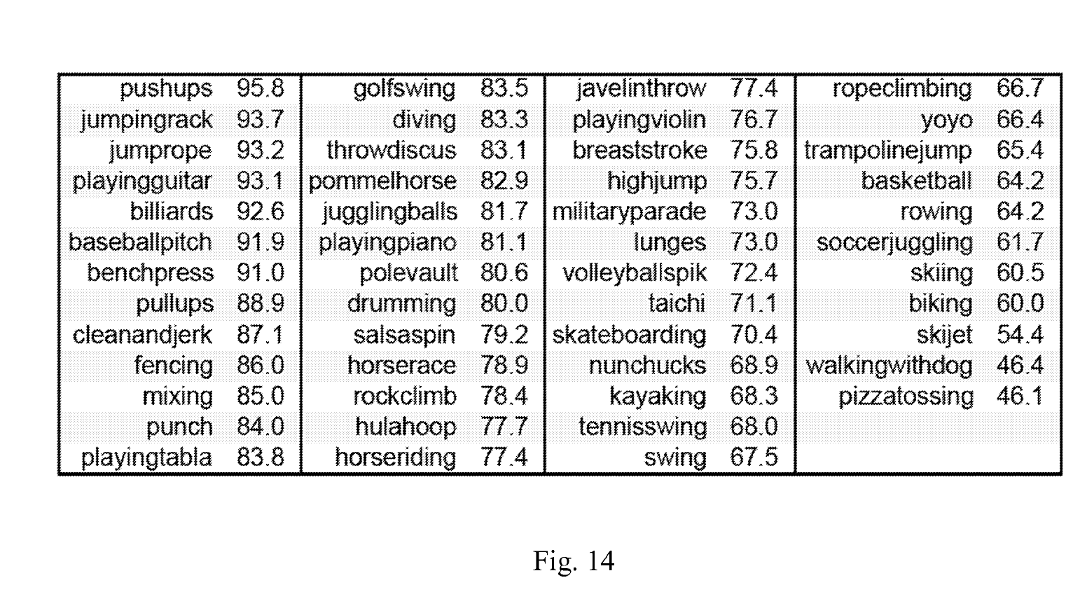

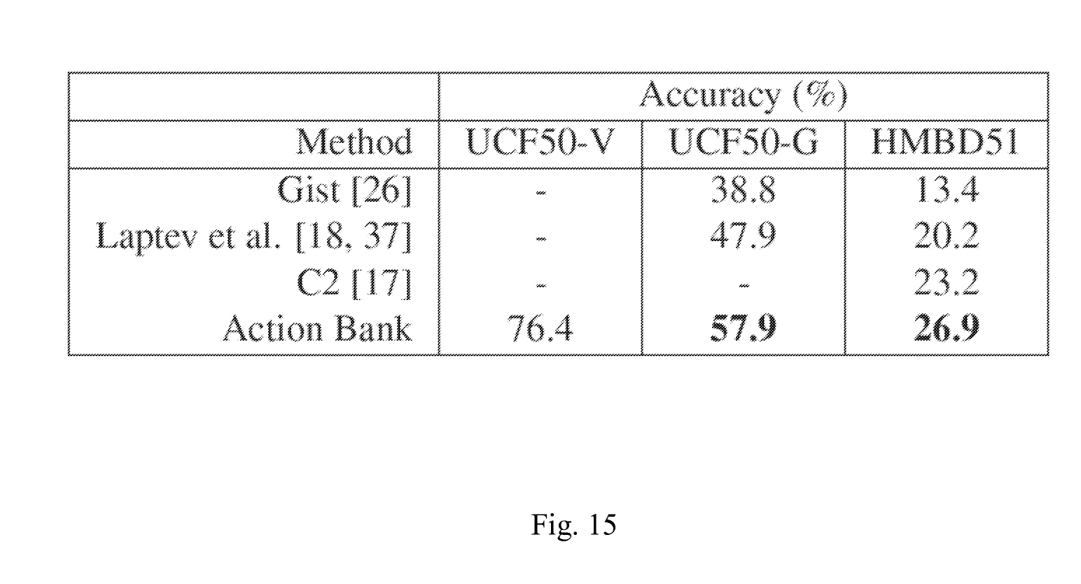

The UCF50 data set is better suited to test scalability because it has 50 classes and 6,680 videos. Only two previous methods were known to process the UCF50 data set successfully. However, as shown below, the accuracy of the previous methods are far below the accuracy of the present invention. One embodiment of the present invention processed the UCF50 data set using a single scale and computed the results through a 10-fold cross-validation experiment. The results are shown in FIG. 8, FIG. 14, and FIG. 15. FIG. 15 illustrates comparing overall accuracy on UCF50 and HMDB51 (−V specifies video-wise CV, and −G group-wise CV).

The confusion matrix of FIG. 8 shows a dominating diagonal with no stand-out confusion among classes. Most frequently, skijet and rowing are inter-confused and yoyo is confused as nunchucks. Pizza-tossing is the worst performing class (46.1%) but its confusion is rather diffuse. The generalization from the datasets with much less classes to UCF50 is encouraging for the present invention.

The Action Bank representation is constructed to be semantically rich. Even when paired with simple linear SVM classifiers, Action Bank is capable of highly discriminative performance.

The Action Bank embodiment was tested on three major activity recognition benchmarks. In all cases, Action Bank performed significantly better than the prior art. Namely, Action Bank scored 97.8% on the KTH dataset (better by 3.3%), 95.0% on the UCF Sports (better by 3.7%) and 76.4% on the UCF50 (baseline scores 47.9%). Furthermore, when the Action Bank's classifiers are analyzed, a strong transfer of semantics from the constituent action detectors to the bank classifier can be found.

In another embodiment, the present invention is a method for building a high-level representation using the output of a large bank of individual, viewpoint-tuned action detectors.

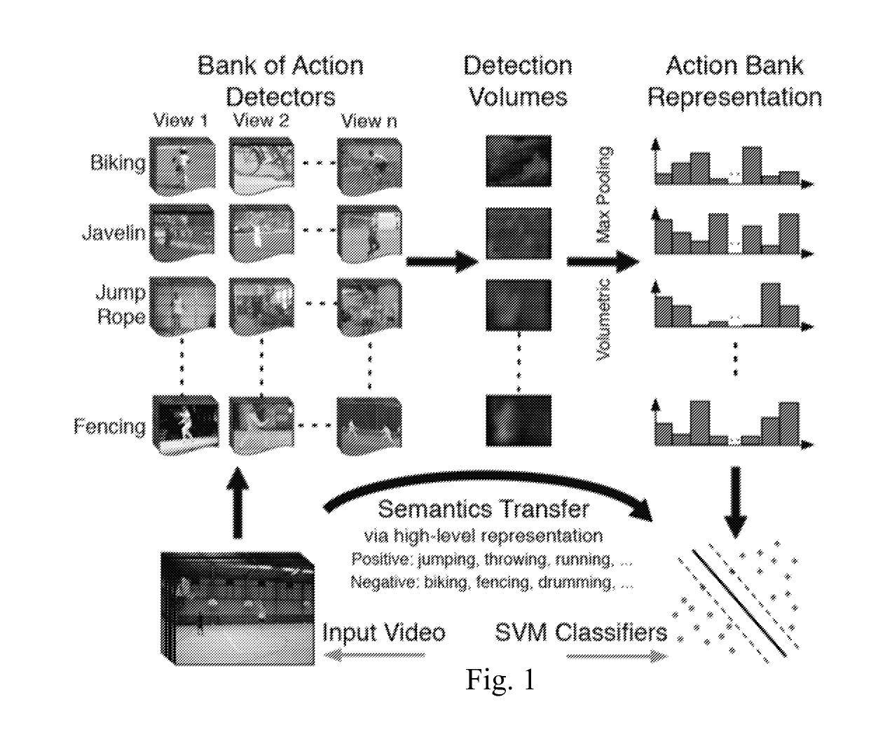

Action Bank explores how a large set of action detectors combined with a linear classifier can form the basis of a semantically-rich representation for activity recognition and other video understanding challenges. FIG. 1 shows an overview of the Action Bank method. The individual action detectors in the Action Bank are template-based. The action detectors are also capable of localizing action (i.e., identifying where an action takes place) in the video.

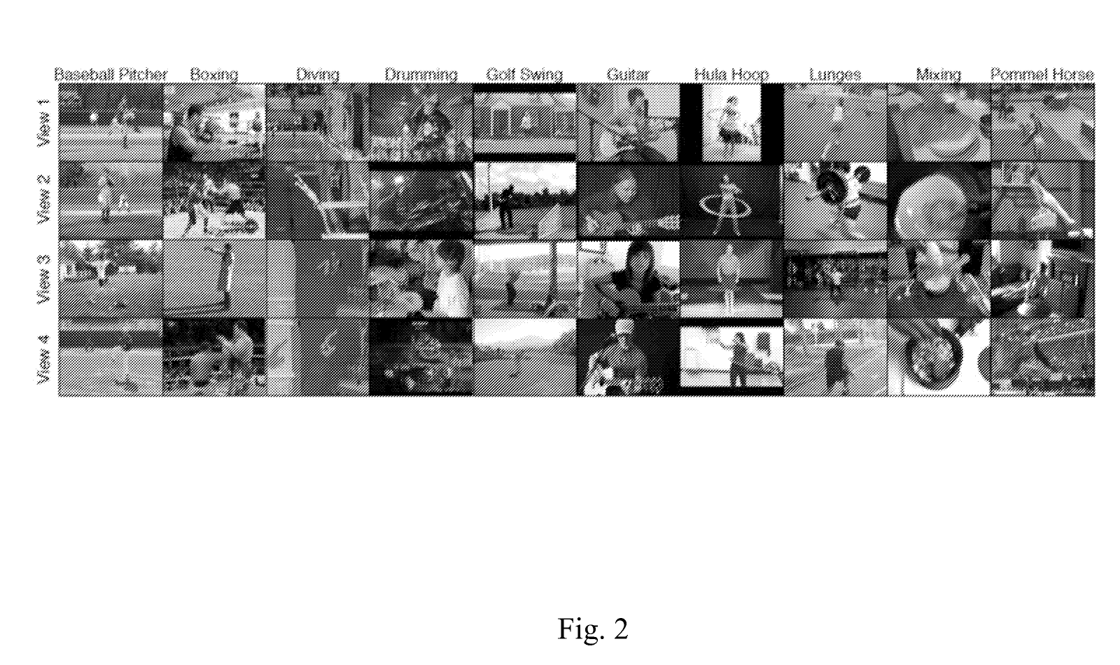

Individual detectors in Action Bank are selected for view-specific actions, such as “running-left” and “biking-away,” and may be run at multiple scales over the input video (many examples of individual detectors are shown in FIG. 2). FIG. 2 is a montage of entries in an action bank. Each entry in the bank is a single template video example the columns depict different types of actions, e.g., a baseball pitcher, boxing, etc. and the rows indicate different examples for that action. Examples are selected to roughly sample the action's variation in viewpoint and time (but each is a different video/scene, i.e., this is not a multiview requirement). The outputs of the individual detectors may be transformed into a feature vector by volumetric max-pooling. Although the resulting feature vector is high-dimensional, a Support Vector Machine (SVM) classifier is able to enforce sparsity among its representation.

In one embodiment, the method is configured to process longer videos. For example, the method may provide a streaming bank where long videos are broken up into smaller, possibly overlapping, and possibly variable sized sub-videos. The sub-videos should be small enough to process through the bank effectively without suffering from temporal parallax. Temporal parallax may occur when too little information is located in one sub-video, thus failing to contain enough discriminative data. One embodiment may create overlapping sub-videos of a fixed size for computational simplicity. The sub-videos may be processed in a variety of ways. One such way is known as full supervision. In a full supervision case, then, we have two scenarios: (1) full supervision and (2) weak supervision. In the full supervision case, each sub-video is given a label based on the activity detected in the sub-video. To classify a full supervision video, the labels from the sub-videos are combined. For example, each label may be treated like a vote (i.e., the action detected most often by the sub-videos is transferred to the full video. The labels may also be weighted by a confidence factor calculated from each sub-video. In a weak supervision case, there is just one label over all of the sub-videos. Although the weak supervision case has its computational advantages, it is also difficult to tell which of the sub-videos the true positive is. To overcome this problem, Multiple Instance Learning methods can be used, which can handle this case for training and testing. For example, a multiple instance SVM or multiple instance boosting method may be used.

As described herein, Action Bank establishes a high-level representation built atop low-level individual action detectors. This high-level representation of human activity is capable of being the basis of a powerful activity recognition method, achieving significantly better than state-of-the-art accuracies on every major activity recognition benchmark attempted, including 97.8% on KTH, 95.0% on UCF Sports, and 76.4% on the full UCF50. Furthermore, Action Bank also transfers the semantics of the individual action detectors through to the final classifier.

Action Bank's template-based detectors perform recognition by detection (frequently through simple convolution) and do not require complex human localization, tracking or pose. One such template representation is based on oriented spacetime energy, e.g., leftward motion and flicker motion, and is invariant to (spatial) object appearance, and efficiently computed by separable convolutions and forgoes explicit motion computation. Action Bank uses this approach for its individual detectors due to its capability (invariant to appearance changes), simplicity, and efficiency.

Action Bank represents a video as the collected output of one or more individual action detectors, each detector outputting a correlation volume. Each individual action detector is invariant to changes in appearances, but as a whole, the action detectors should be selected to infuse robustness/invariance to scale, viewpoint, and tempo. To account for changes in scale, the individual detectors may be run at multiple scales. But, to account for viewpoint and tempo changes, multiple detectors may sample variations for each action. For example, FIG. 2 demonstrates one such sampling. The left-most column shows individual action detectors for a baseball pitcher sampled from the front, left-side, rightside and rear. In the second-column, both one and two-person boxing are sampled in quite different settings.

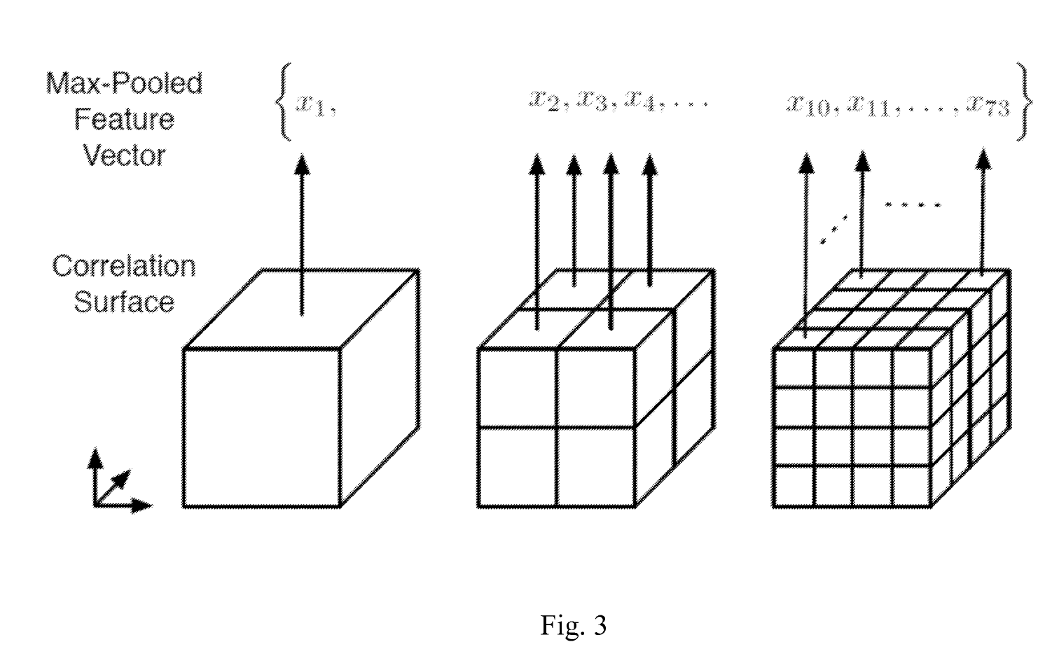

One embodiment of the Action Bank has Nₐ individual action detectors. Each individual action detector is run at Nₛ spatiotemporal scales. Thus, Nₐ×Nₛ correlation volumes will be created. As illustrated in FIG. 3, a max-pooling method can be applied to the volumetric case. Volumetric max-pooling extracts a spatiotemporal feature vector from the correlation output of each action detector. In this example, a three-level octree can be created. For each action-scale pair, this amounts to 80+81+82=73-dimension vector. The total length of the calculated Action Bank feature vector is therefore Nₐ×Nₛ×73.

Because Action Bank uses template-based action detectors, no training of the individual action detectors is required. The individual detector templates in the bank may be selected manually or programmatically.

In one embodiment, the individual action detector templates may be selected automatically by selecting best-case templates from among possible templates. In another embodiment, a manual selection of templates has led to a powerful bank of individual action detectors that can perform significantly better than current methods on activity recognition benchmarks.

An SVM classifier can be used on the Action Bank feature vector. In order to prevent overfitting, regularization may be employed in the SVM. In one embodiment, L2 regularization may be used. L2 regularization may be preferred to other types of regularization, such as structural risk minimization, due to computational requirements.

In one embodiment, a spatiotemporal action detector may be used. The spatiotemporal detector has some desirable properties, including invariance to appearance variation, evident capability in localizing actions from a single template, efficiency (e.g., action spotting is implementable as a set of separable convolutions), and natural interpretation as a decomposition of the video into space-time energies like leftward motion and flicker.

In one embodiment, template matching is performed using a Bhattacharya coefficient M(•) when correlating the template T with a query video V:

$$M ( x ) = {\sum }_{u} m ( V ( x - u ) , T ( u ) ) \qquad Eq . 4$$

where u ranges over the spatiotemporal support of the template volume and M(x) is the output correlation volume. The correlation is implemented in the frequency domain for efficiency. Conveniently, the Bhattacharya coefficient bounds the correlation values between 0 and 1, with 0 indicating a complete mismatch and 1 indicating a complete match. This gives an intuitive interpretation for the correlation volume that is used in volumetric max-pooling, however, other ranges may be suitable.

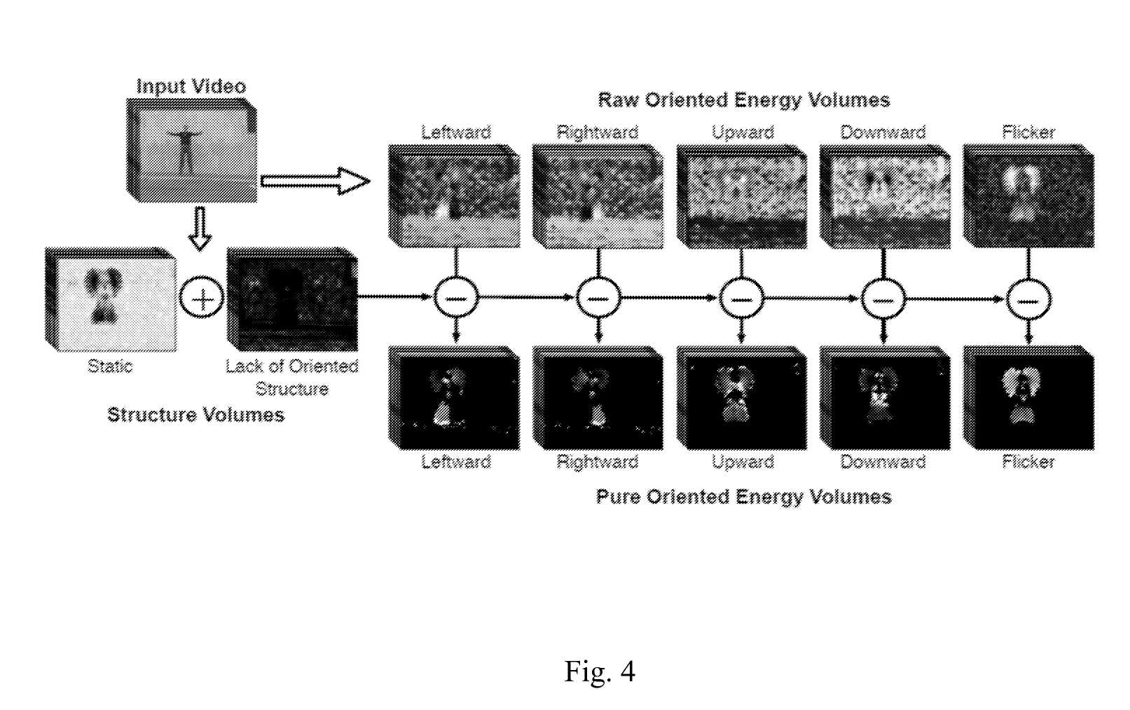

FIG. 4 illustrates a schematic of the spatiotemporal orientation energy representation that may be used for the action detectors in one embodiment of the present invention. A video may be decomposed into seven canonical space-time energies: leftward, rightward, upward, downward, flicker (very rapid changes), static, and lack of oriented structure; the last two are not associated with motion and are hence used to modulate the other five (their energies are subtracted from the raw oriented energies) to improve the discriminative power of the representation. The resulting five energies form an appearance-invariant template.

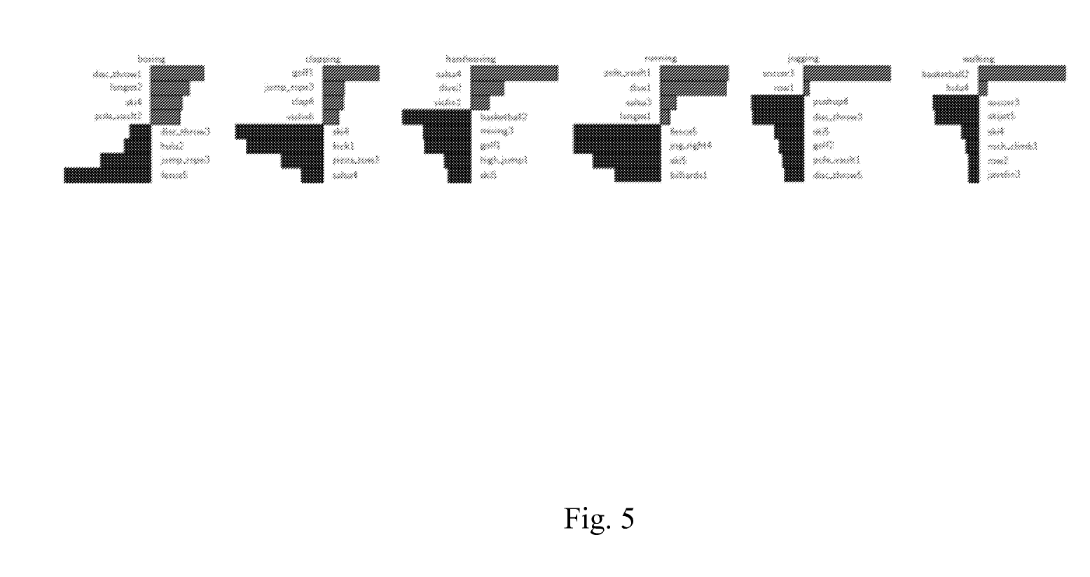

Given the high-level nature of the present invention, it is advantageous when the semantics of the representation transfer into the classifiers. For example, the classifier learned for a running activity may pay more attention to the running-like entries in the bank than it does other entries, such as spinning-like. Such an analysis can be performed by plotting the dominant (positive and negative) weights of each one-vs-all SVM weight vector. FIG. 5 is one example of such a plot. In FIG. 5, weights for the six classes in KTH are plotted. The top four weights (when available; in red; these are positive weights) and the bottom-four weights (or more when needed; in blue; these are negative weights) are shown. In other words, FIG. 5 shows relative contribution of the dominant positive and negative bank entries for each one-vs-all SVM on the KTH data set. The action class is named at the top of each bar-chart; red (blue) bars are positive (negative) values in the SVM vector. The number on bank entry names denotes which example in the bank (recall that each action in the bank has 3-6 different examples). Note the frequent semantically meaningful entries; for example, “clapping” incorporates a “clap” bank entry and “running” has a “jog” bank entry in its negative set.

Close inspection of which bank entries are dominating verifies that some semantics are transferred into the classifiers. But, some unexpected transfer happens as well. Encouraging semantics-transfers (in these examples, “clap4,” “violin6,” “soccer3,” “jog_right4,” “pole_vault4,” “ski4,” “basketball2,” and “hula4” are names of individual templates in our action bank) include, but are not limited to positive “clap4” selected for “clapping” and even “violin6” selected for “clapping” (the back and forth motion of playing the violin may be detected as clapping). In another example, positive “soccer3” is selected for “jogging” (the soccer entries are essentially jogging and kicking combined) and negative “jog right4” for “running”. Unexpected semantics-transfers include positive “pole vault4” and “ski4” for “boxing” and positive “basketball2” and “hula4” for “walking.”

In some embodiments, a group sparsity regularizer may not be used, and despite the lack of such a regularizer, a gross group sparse behavior may be observed. For example, in the jogging and walking classes, only two entries have any positive weight and few have any negative weight. In most cases, 80-90% of the bank entries are not selected, but across the classes, there is variation among which are selected. This is because of the relative sparsity in the individual action detector outputs when adapted to yield pure spatiotemporal orientation energy.

One exemplary embodiment comprised of 205 individual template-based action detectors selected from various action classes (e.g., the 50 action classes used in UCF50 and all six action classes from KTH). Three to four individual template-based action detectors for the same action comprised of video shot from different views and scales. The individual template-based action detectors have an average spatial resolution of approximately 50 120 pixels and a temporal length of 40-50 frames.

In some embodiments, a standard SVM is used to train the classifiers. However, given the emphasis on sparsity and structural risk minimization in the original, the performance of one embodiment of the present invention was tested when used as a representation for other classifiers, including a feature sparsity L1-regularized logistic regression SVM (LR1) and a random forest classifier (RF). The performance of one embodiment of the present invention dropped to 71.1% on average when evaluated with LR1 on UCF50. RF was evaluated on the KTH and UCFSports datasets and scored 96% and 87.9%, respectively. These efforts have demonstrated a degree of robustness inherent in the present invention (i.e., classifier accuracy does not drastically change).

One factor in the present invention is the generality of the invention to adapt to different video understanding settings. For example, if a new setting is required, more action detectors can be added to the action detector bank. However, it is not given that a large bank necessarily means better performance. In fact, dimensionality may counter this intuition.

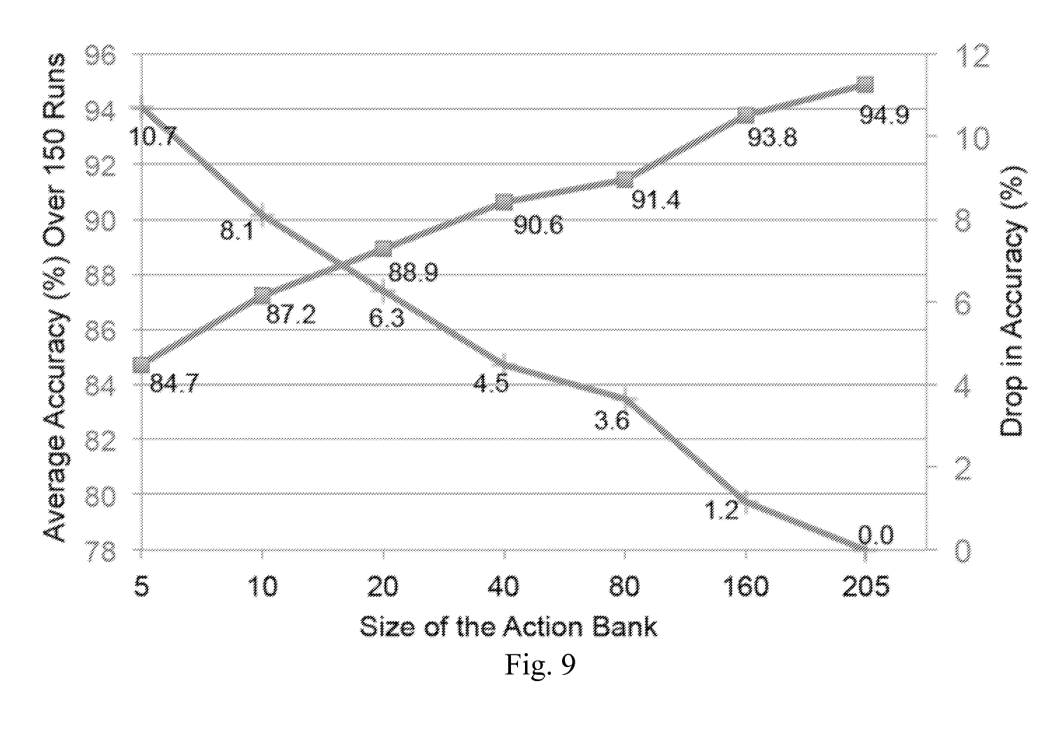

To assess the efficient size of an action detector bank, experiments were conducted using action detector banks of various sizes (i.e., from 5 detectors to 205 detectors). For each different size k, 150 iterations were run in which k detectors were randomly sampled from the full bank and a new bank was constructed. Then, a full leave-one-out cross validation was performed on the UCF Sports dataset. The results are reported in FIG. 9, and although a larger bank does indeed perform better, the benefits are marginal. The red curve plots this average accuracy and the blue curve plots the drop in accuracy for each respective size of the bank with respect to the full bank. These results are on the UCF Sports data set. The results show that the strength of the method is maintained even for banks half as big. With a bank of size 80, one embodiment of the present invention was able to match the existing state of the art scores. A larger bank may drive accuracy higher.

If the processing is parallelized over 12 CPUs by running the video over elements in the bank in parallel, the mean running time can be drastically reduced to 1,158 seconds (19 minutes) with a range of 149-12,102 seconds (2.5-202 minutes) and a median of 1,156 seconds (19 minutes).

One embodiment iteratively applies the bank on streaming video by selectively sampling frames to compute based on an early coarse resolution computation.

The present invention is a powerful method for carrying out high-level activity recognition on a wide variety of realistic videos “in the wild.” This high-level representation has rich applicability in a wide-variety of video understanding problems. In one embodiment, the invention leverages the fact that a large number of smaller action detectors, when pooled appropriately, can provide high-level semantically rich features that are superior to low-level features in discriminating videos—the results shows a significant improvement on every major benchmark, including 76.4% accuracy on the full UCF50 dataset when baseline low-level features yield 47.9%. Furthermore, the present invention also transfers the semantics of the individual action detectors through to the final classifier.

For example, the performance of one embodiment of the present invention was tested on the two standard action recognition benchmarks: KTH and UCFSports. In these experiments, we run the action bank at two scales. On KTH (FIG. 12 and FIG. 6), a leave-one-out cross-validation strategy is used. The tested embodiment scored at 97.8% and outperforms all other methods, three of which share the current best performance of 94.5%. Most of the previous methods reporting high scores are based on feature points and hence have quite a distinct character from the present invention. The present invention outperforms the previous methods by learning classes of actions that the previous methods often confuse. For example, one embodiment of the present invention perfectly learns jogging and running—an area that previous methods found challenging.

A similar leave-one-out cross-validation strategy is used for UCF Sports, but the strategy does not engage in horizontal flipping of the data. Again, the performance of one embodiment of the invention is at 95% accuracy which is better than all contemporary methods, who achieve at best 91.3% (FIG. 13, FIG. 7).

These two sets of results demonstrate that the present invention is a notable new representation for human activity in video and capable to robust recognition in realistic settings. However, these two benchmarks are small. One embodiment of the present invention was tested against a much more realistic benchmark which is an order of magnitude larger in terms of classes and number of videos.

The UCF50 data set is better suited to test scalability because it has 50 classes and 6,680 videos. Only two previous methods were known to process the UCF50 data set successfully. However, as shown below, the accuracy of the previous methods are far below the accuracy of the present invention. One embodiment of the present invention processed the UCF50 data set using a single scale and computed the results through a 10-fold cross-validation experiment. The results are shown in FIG. 8, FIG. 14, and FIG. 15. FIG. 15 illustrates comparing overall accuracy on UCF50 and HMDB51 (−V specifies video-wise CV, and −G group-wise CV).

The confusion matrix of FIG. 8 shows a dominating diagonal with no stand-out confusion among classes. Most frequently, skijet and rowing are inter-confused and yoyo is confused as nunchucks. Pizza-tossing is the worst performing class (46.1%) but its confusion is rather diffuse. The generalization from the datasets with much less classes to UCF50 is encouraging for the present invention.

The following is one exemplary embodiment of a method according to the present invention implemented in PYTHON psuedo-code.

actionbank.py—Description: The main driver method for one embodiment of the present invention.

class ActionBank(object): ““Wrapper class storing the data/paths for an ActionBank’”

def_init_(selfibankpath): “‘Initialize the bank with the template paths.’”

self.bankpath = bankpath
self.templates = os.listdir(bankpath)
self.size = len(self.templates)
self.vdim = 73 # hard-coded for now
self.factor = 1
def load_single(self,i): “‘ Load the ith template from the disk. ’”
fp = gzip.open(path.join(self.bankpath,self.templates[i]),“rb”)
T = np.float32(np.load(fp)) # force a float32 format
fp.close( )
#print “loading %s” % self.templates[i]
# downsample if we need to
if self.factor != 1:

T = spotting.call_resample_with_7D(T,self.factor)

return T

def apply_bank_template(AB,query,template_index,maxpool=True): ‘“Load the bank template (at template_index) and apply it to the query video (already featurized).’”

if verbose:

ts = t.time( )

template = AB.load_single(template_index)
temp_corr=spotting.match_bhatt(template,query)
temp_corr*=255
temp_corr=np.uint8(temp_corr)
if not maxpool:

return temp_corr

pooled_values=[ ]
max_pool_3D(temp_corr,2,0,pooled_values)
return pooled_values

def bank_and_save(AB,f,out_prefix,cores=1): “‘Load the featurized video (from raw path ‘f’ that will be translated to featurized video path) and apply the bank to it aynchronously. AB is an action bank instance (pointing to templates). If cores is not set or set to 0, a serial application of the bank is made.’”

# first check if we actually need to do this process
oname = out_prefix + banked_suffix
if path.exists(oname):

print “***skipping the bank on video %s (already cached)”%f,
return

print “***running the bank on video %s”%f,
oname = out_prefix + featurized_suffix
if not path.exists(oname):

print “Expected the featurized video at %s, not there???
(skipping)”%oname
return

fp = gzip.open(oname,“rb”)
featurized = np.load(fp)
fp.close( )
banked = np.zeros(AB.size*AB.vdim, dtype=np.uint8( ))
if cores == 1:

for k in range(AB.size):

banked [k*AB.vdim:k*AB.vdim+AB.vdim] =
apply_bank_template
(AB,featurized,k)

else:

res_ref = [None] * AB.size
pool = multi.Pool(processes = cores)
for j in range(AB.size):

res_ref[j] = pool.apply_async(apply_bank_template,
(AB,featurized,j))

pool.close( )
pool.join( ) # forces us to wait until all of the pooled jobs
are finished
for k in range(AB.size):

banked [k*AB.vdim:k*AB.vdim+AB.vdim] =
np.array(res_ref[k].get( ))

oname = out_prefix + banked_suffix
fb = gzip.open(oname,“wb”)
np.save(fp,banked)
fp.close( )

def featurize_and_save (f,out_prefix, factor=1, postfactor=1, maxcols=None, lock=None): “‘Featurize the video at path ‘f’. But first, check if it exists on the disk at the output path already, if so, do not compute it again, just load it. Lock is a semaphore (multiprocessing.Lock) in the case this is being called from a pool of workers. This function handles both the prefactor and the postfactor parameters. Be sure to invoke actionbank.py with the same −f and −g parameters if you call it multiple times in the same experiment. _featurize.npz′ is the format to save them in.’”

```
oname = out_prefix + featurized_suffix
if not path.exists(oname):
  print oname, “computing”
  featurized =
  spotting.featurize_video(f,factor=factor,maxcols=maxcols,lock=lock)
  if postfactor != 1:
```

featurized = spotting.call_resample_with_7D(featurized,postfactor)

```
  of = gzip.open(oname,“wb”)
  np.save(of,featurized)
  of.close( )
else:
  print oname, “skipping; already cached”
```

def slicing_featurize_and_bank(f, out_prefix, AB, factor=1, postfactor=1, maxcols=None, slicing=300, overlap=None, cores=1): “‘Featurize and Bank the video at path ‘f’ in slicing mode: Do it for every “slicing” number of frames (with “overlap”) featurize the video, apply the bank and do max pooling. If overlap is None then slicing/2 is used. For no overlap, set it to 0. Note that we do not let slices of less than 15 frames get computed. If there would be a slice of so few frames (at the end of the video), it is skipped. This also implies that the slicing parameter should be larger than 15 . . . . The default is 300 . . . ’”

if not os.path.exists(f):

raise IOError(f + ‘ not found’)

numframes = video.countframes(f)
if verbose:

print “have %d frames” % numframes

# manually handle the clip-wise loading and processing here
(width,height,channels) = video.query_framesize(f,factor,maxcols)
td = tempfile.mkdtemp( )
if not os.path.exists(td):

os.makedirs(td);

ffmpeg_options = [‘ffmpeg’, ‘-i’, f,‘-s’, ‘%dx%d’%(width,height) ,‘-sws_flags’, ‘bicubic’,‘%s’ %
(os.path.join(td,‘frames%06d.png’))]
fpipe = subp.Popen(ffmpeg_options,stdout=subp.PIPE, stderr=subp.PIPE)
fpipe.communicate( )
frame_names = os.listdir(td)
frame_names.sort( )
numframes = len(frame_names) # number may change by one or two...
if overlap is None:

overlap = (int)(slicing / 2)

if overlap > slicing:

print “The overlap is greater than the slicing. This makes me crash!!!”

start = 0, index = 0
log = open( ‘%s.log’%out_prefix, ‘w’)
while start < numframes:

end = min(start + slicing,numframes)
frame_count = end − start
if frame_count < 15:

break

# write out the slice information to the log file for this video
log.write(‘%d,%d,%d\n’%(index,start,end))
if verbose:
print “[%02d] %04d--%04d (%04d)”%(index,start,end,frame_count)

vid = video.Video(frames=frame_count, rows=height, columns=width, bands=channels,
dtype=np.uint8)
for i, fname in enumerate(frame_names[start:end]):

fullpath = os.path.join(td, fname)
img_array = pylab.imread(fullpath)
# comes in as floats (0 to 1 inclusive) from a png file
img_array = video.float_to_uint8(img_array)
vid.V[i, ...] = img_array

# the sliced video is now in vid.V
slice_out_prefix = ‘%s_s %04d’%(out_prefix,index)
featurize_and_save(vid,slice_out_prefix,postfactor=postfactor)
bank_and_save(AB,‘%s_{——}slice %04d’%(f,index),slice_out_prefix,cores)
start += slicing − overlap
index += 1
log.close( )
# now, let's load all of the banked vectors and create a bag. get the length of a banked vector first
fn = ‘%s_s%04d%s’ % (out_prefix,0,banked_suffix)
fp = gzip.open(fn,“rb”)
vlen = len(np.load(fp))
fp.close( )
bag = np.zeros( (index,vlen), np.uint8)
for i in range(index):

fn = ‘%s_s%04d%s’ % (out_prefix,i,banked_suffix)
fp = gzip.open(fn,“rb”)
bag[i][:] = np.load(fp)
fp.close( )

fn = ‘%s_bag%s’ % (out_prefix,banked_suffix)
fp = gzip.open(fn,“wb”)
np.save(fp,bag)
fp.close( )
### done concatenating all of the vector, need to remove all of the temporary files
shutil.rmtree(td)

def streaming_featurize_and_bank(f, out_prefix, AB,factor=1, postfactor=1, maxcols=None, streaming=300, tbuflen=50, cores=1): “‘Featurize and Bank the video at path ‘f’ in streaming mode: Do it for every “streaming” number of frames. Tbuflen specifies the overlap in time (before and after) each clip to be loaded allows for exact computation without boundary errors in the convolution/banking’”

if not os.path.exists(f):

raise IOError(f + ‘ not found’)

# first check if we actually need to do this process
oname = out_prefix + banked_suffix
if path.exists(oname):

print “***skipping the bank on video %s (already cached)”%f,
return

numframes = video.countframes(f)
if numframes < streaming:

# just do normal processing
featurize_and_save(f,out_prefix,factor=factor,postfactor=postfactor,maxcols=maxcols)
bank_and_save(AB,f,out_prefix,cores)
return

# manually handle the clip-wise loading and processing here
(width,height,channels) = video.query_framesize(f,factor,maxcols)
td = tempfile.mkdtemp( )
if not os.path.exists(td):

os.makedirs(td);

ffmpeg_options = [‘ffmpeg‘, ‘-i’, f, ‘-s’, ‘%dx%d’%(width,height), ‘-sws_flags’, ’bicubic’, ‘%s’ %

(os.path.join(td,‘frames%06d.png’))]

fpipe = subp.Popen(ffmpeg_options,stdout=subp.PIPE,stderr=subp.PIPE)
fpipe.communicate( )
frame_names = os.listdir(td)
frame_names.sort( )
numframes = len(frame_names) # number may change by one or two...
rounds = numframes/streaming
if rounds*streaming < numframes:

rounds += 1

# output featurized width and height after postfactor downsampling
fow = 0
foh = 0
for r in range(rounds):

start = r*streaming
end = min(start + streaming,numframes)
start_process = max(start − tbuflen,0)
end_process = min(end + tbuflen,numframes)
start_diff = start−start_process
end_diff = end_process−end
duration = end−start
frame_count = end_process − start_process
if verbose:

print “[%02d] %04d--%04d %04d--%04d %04d--%04d

(%04d)”%(r,start,end,start_process,end_process,start_diff,end_diff,frame_count)

vid = video.Video(frames=frame_count, rows=height, columns=width, bands=channels,

dtype=np.uint8)

for i, fname in enumerate(frame_names[start_process:end_process]):

fullpath = os.path.join(td, fname)
img_array = pylab.imread(fullpath)
# comes in as floats (0 to 1 inclusive) from a png file
img_array = video.float_to_uint8(img_array)
vid.V[i, ...] = img_array

# now do featurization and banking
oname = os.path.join(td,‘temp%04d_‘%r + featurized_suffix)
featurized = spotting.featurize_video(vid)
if postfactor != 1:

featurized = spotting.call_resample_with_7D(featurized,postfactor)

if fow==0:

fow = featurized.shape[2]
foh = featurized.shape[1]

of = gzip.open(oname,“wb”)
np.save(of,featurized[start_diff:start_diff+duration])
of.close( )
# now, we want to apply the bank on this particular clip
banked = np.zeros(AB.size*AB.vdim, dtype=np.uint8( ))
res_ref = [None] * AB.size
pool = multi.Pool(processes = cores)
maxpool=False
for j in range(AB.size):

res_ref[j] = pool.apply_async(apply_bank_template, (AB,featurized,j,maxpool))

pool.close( )
pool.join( ) # forces us to wait until all of the pooled jobs are finished
bb = [ ]
for k in range(AB.size):

B = res_ref[k].get( )
bb.append(B[start_diff:start_diff+duration])

oname = os.path.join(td,‘temp%04d_‘%r + banked_suffix)
fp = gzip.open(oname,“wb”)
np.save(fp,np.asarray(bb))
fp.close( )

# load in all of the featurized videos
F = np.zeros([numframes,foh,fow,7],dtype=np.float32)
for r in range(rounds):

oname = os.path.join(td,‘temp%04d_’%r + featurized_suffix)
of = gzip.open(oname)
A = np.load(of)
of.close( )
if r == rounds−1:

F[r*streaming:,...] = A

else:

F[r*streaming:r*streaming+streaming,...] = A

oname = out_prefix + featurized_suffix
of = gzip.open(oname,“wb”)
np.save(of,F)
of.close( )
# load in all of the correlation volumes into one array and do max-pooling. Still has a high

memory requirement -- other embodiments may perform this differently, especially if max-
pooling over a large video.

F = np.zeros([AB.size,numframes,foh,fow],dtype=np.uint8)
for r in range(rounds):

oname = os.path.join(td,‘temp%04d_’%r + banked_suffix)
of = gzip.open(oname)
A = np.load(of)
of.close( )
if r == rounds−1:

F[:,r*streaming:,...] = A

else:

F[:,r*streaming:r*streaming+streaming,...] = A

banked = np.zeros(AB.size*AB.vdim, dtype=np.uint8( ))
for k in range(AB.size):

temp_corr = np.squeeze(F[k,...])
pooled_values=[ ]
max_pool_3D(temp_corr,2,0,pooled_values)
banked[k*AB.vdim:k*AB.vdim+AB.vdim] = pooled_values

oname = out_prefix + banked_suffix
of = gzip.open(oname,“wb”)
np.save(of,banked)
of.close( )
# need to remove all of the temporary files
shutil.rmtree(td)

def add_to_bank(bankpath,newvideos): “‘Add video(s) as new templates to the bank at path bankpath.’”

if not path.isdir(newvideos):

(h,t) = path.split(newvideos)

print “adding %s\n”%(newvideos)
F = spotting.featurize_video(newvideos);
of = gzip.open(path.join(bankpath,t+“.npy.gz”),“wb”)
np.save(of,F)
of.close( )

else:

files = os.listdir(newvideos)
for f in files:

F = spotting.featurize_video(path.join(newvideos,f));
(h,t) = path.split(f)
print “adding %s\n”%(t)
of = gzip.open(path.join(bankpath,t+“.npy.gz”),“wb”)
np.save(of,F)
of.close( )

def max_pool_{—}3D(array_input,max_level,curr_level,output): “‘Takes a 3D array as input and outputs a feature vector containing the max of each node of the octree, max_level takes the max levels of the octree and starts at ‘0’, output is a linkedlist. So if max-levels=3, then actually 4 levels of octree will be calculated i.e: 0, 1, 2, 3 . . . REMEMBER THIS! curr_level is just for programmatic use and should always be set to 0 when the function is being called’”

#print ‘In level ’ + str(curr_level)
if curr_level>max_level :

return

else:

| max_val = | array_input.max( ) |
|---|---|
| #print str(max_val) +‘’ +str(i) | |
| frames = | array_input.shape[0] |
| rows = | array_input.shape[1] |
| cols = | array_input.shape[2] |

#np.concatenate((output,[max_val]))
#output[i]=max_val
#i+=1
output. append(max_val)

max_pool_3D(array_input[0:frames/2,0:rows/2,0:cols/2],max_level,curr_level+1,output)
max_pool_3D(array_input[0:frames/2,0:rows/2,cols/2+1:cols],max_level,curr_level+1,o

utput)

max_pool_3D(array_input[0:frames/2,rows/2+1:rows,0:cols/2],max_level,curr_level+1,o

utput)

max_pool_3D(array_input[0:frames/2,rows/2+1:rows,cols/2+1:cols],max_level,curr_leve

l+1,output)

max_pool_3D(array_input[frames/2+1:frames,0:rows/2,0:cols/2],max_level,curr_level+1

,output)

max_pool_3D(array_input[frames/2+1:frames,0:rows/2,cols/2+1:cols],max_level,curr_le

vel+1,output)

max_pool_3D(array_input[frames/2+1:frames,rows/2+1:rows,0:cols/2],max_level,curr_l

evel+1,output)

max_pool_3D(array_input[frames/2+1:frames,rows/2+1:rows,cols/2+1:cols],max_level,c

urr_level+1,output)

def max_pool_{—}2D(array_input,max_level,curr_level,output): “‘Takes a 3D array as input and outputs a feature vector containing the max of each node of the octree, max_level takes the max levels of the octree and starts at ‘0’, output is a linkedlist. So if max-levels=3, then actually 4 levels of octree will be calculated i.e: 0, 1, 2, 3 . . . REMEMBER THIS! curr_level is just for programmatic use and should always be set to 0 when the function is being called’”

#print ‘In level’ + str(curr_level)
if curr_level>max_level:

return

else:

| max_val = | array_input.max( ) |
|---|---|
| #print str(max_val) +‘’ +str(i) | |
| rows = | array_input.shape[0] |
| cols = | array_input.shape[1] |

output. append(max_val)
max_pool_2D(array_input[0:rows/2,0:cols/2],max_level,curr_level+1,output)

max_pool_2D(array_input[0:rows/2,cols/2+1:cols],max_level,curr_level+1,output)
max_pool_2D(array_input[rows/2+1:rows,0:cols/2],max_level,curr_level+1,output)
max_pool_2D(array_input[rows/2+1:rows,cols/2+1:cols],max_level,curr_level+1,output)

if_name_==‘_main_’:

parser=argparse.ArgumentParser(description=“Main routine to transform one or more videos into their respective action bank representations.\
The system produces some intermediate files along the way and is somewhat computationally intensive. Before executing some intermediate computation, it will always first check if the file that it would have produced is already present on the file system. If it is not present, it will regenerate. So, if you ever need to run from scratch, be sure to specify a new output directory.”,

formatter_class=argparse.ArgumentDefaultsHelpFormatter)
parser.add_argument(“-b”, “--bank”, default=“../bank_templates/”, help=“path to the directory

of bank template entries”)

parser.add_argument(“-e”,“--bankfactor”, type=int, default=1, help=“factor to reduce the

computed bank template matrices down by after loading them. The bank videos are computed at
full-resolution and not downsampled (full res is 300-400 column videos).”)

parser.add_argument(“-f”, “--prefactor”, type=int, default=1, help=“factor to reduce the video

frames by, spatially; helps for dealing with larger videos (in x,y dimensions); reduced
dimensions are treated as the standard input scale for these videos (i.e., reduced before
featurizing and bank application)”)

parser.add_argument(“-g”, “--postfactor”, type=int, default=1, help=“factor to further reduce

the already featurized videos. The postfactor is applied after featurization (and for space and
speed concerns, the cached featurized videos are stored in this postfactor reduction form; so, if
you use actionbank.py in the same experiment over multiple calls, be sure to use the same -f and
-g parameters.)”)

parser.add_argument(“-c”, “--cores”, type=int, default=2, help=“number of cores(threads) to

use in parallel”)

parser.add_argument(“-n”,“--newbank”, action=“store_true”, help=“SPECIAL mode: create a

new bank or add videos into the bank. The input is a path to a single video or a folder of videos
that you want to be added to the bank path at \‘--bank\’, which will be created if needed. Note
that all downsizing arguments are ignored; the new video should be in exactly the dimensions
that you want to use to add.”)

parser.add_argument(“-s”, “--single”, action=“store_true”, help=“input is just a single video

and not a directory tree”)

parser.add_argument(“-v”, “--verbose”, action=“store_true”, help=“allow verbose output of

commands”)

parser.add_argument(“-w”,“--maxcols”, type=int, help=“A different way to downsample the

videos, by specifying a maximum number of columns.”)

parser.add_argument(“-S”, “--streaming”, type=int, default=0, help=“SPECIAL mode: process

the video as if it is a stream, which means every -S frames will be processed separately (but
overlapping for proper boundary effects) and then concatenated together to produce the output.”)

parser.add_argument(“-L”, “--slicing”, type=int, default=0, help=“SPECIAL mode: process a

long video in simple slices, which means every -L frames will be processed separately (but
overlapping by L/2). Unlike --streaming mode, each -L frames max-pooled outputs are stored
separately. Streaming and slicing are mutually exclusive; so, if -streaming is set, then slicing
will be disregarded, by convention.”)

parser.add_argument(“--sliceoverlap”,type=int, default=−1, help=“For slicing mode only,

specifies the overlap for different slices. If none is specified, then the half the length of a slice is
used.”)

parser.add_argument(“--onlyfeaturize”, action=“store_true”, help=“do not compute the whole

action bank on the videos; rather, just compute and store the action spotting oriented energy
feature videos”)

parser.add_argument(“--testsvm”, action=“store_true”, help=“After running the bank, test

through an svm with k-fold cv. Assumes a two-layer directory structure was used; this is just an
example. The bank representation is the core output of this code.”)

parser.add_argument(“input”, help=“path to the input file/directory”)
parser.add_argument(“output”, nargs=‘?’, default=“/tmp”, help=“path to the output

file/directory”)

args = parser.parse_args( )
verbose = args.verbose
# Notes: Single video and whole directory tree processing are intermingled here.

# Special Mode:

if args.newbank:

add_to_bank(args.bank,args.input)
sys.exit( )

# Preparation
# Replicate the directory tree in the output root if we are processing multiple files
if not args.single:

if args.verbose:

print ‘replicating directory tree for output’

for dirname, dirnames, filenames in os.walk(args.input):

new_dir = dirname.replace(args.input,args.output)
subp.call(‘mkdir ’+new_dir,shell = True)

# First thing we do is build the list of files to process
files = [ ]
if args.single:

files.append(args.input)

else:

if args.verbose:

print ‘getting list of all files to process’

for dirname, dirnames, filenames in os.walk(args.input):

for f in filenames:

files.append(path.join(dirname,f))

# Now, for each video, we go through the action bank process
if (args.streaming == 0) and (args.slicing == 0):

# process in standard “whole video” mode
# Step 1: Compute the Action Spotting Featurized Videos
manager = multi.Manager( )
lock = manager.Lock( )
pool = multi.Pool(processes = args.cores)
for f in files:

pool.apply_async(featurize_and_save,(f,f.replace(args.input,args.output),args.prefactor,args.post
factor,args.maxcols,lock))

pool.close( )
pool.join( )
if args.onlyfeaturize:

sys.exit(0)

# Step 2: Compute Action Bank Embedding of the Videos
# Load the bank itself
AB = ActionBank(args.bank)
if (args.bankfactor != 1):

AB.factor = args.bankfactor

# Apply the bank
# do not do it asynchronously, as the individual bank elements are done that way
for fi,f in enumerate(files):

print “\b\b\b\b\b %02d%%” % (100*fi/len(files))
bank_and_save(AB,f,f.replace(args.input,args.output),args.cores)

elif args.streaming != 0:

# process in streaming mode, separately for each video
print “actionbank: streaming mode”
AB = ActionBank(args.bank)
if (args.bankfactor != 1):

AB.factor = args.bankfactor

for f in files:

if verbose:

ts = t.time( )

streaming_featurize_and_bank(f,f.replace(args.input,args.output),AB,args.prefactor,args.postfact
or,args.maxcols,args.streaming,cores=args.cores)

if verbose:

te = t.time( )
print “streaming bank on %s in %s seconds” % (f,str((te-ts)))

elif args.slicing != 0:

# process in slicing mode, separately for each video
print “actionbank: slicing mode”
if args.sliceoverlap == −1:

sliceoverlap=None

else:

sliceoverlap=args.sliceoverlap

AB = ActionBank(args.bank)
if (args.bankfactor != 1):

AB.factor = args.bankfactor

for f in files:

if verbose:

print “\nslicing bank on %s” % (f)
ts = t.time( )

slicing_featurize_and_bank(f,f.replace(args.input,args.output),AB,args.prefactor,args.postfactor,
args.maxcols,args.slicing,overlap=sliceoverlap,cores=args.cores)

if verbose:

te = t.time( )
print “\nsliced bank on %s in %s seconds\n” % (f,str((te-ts)))

else:

print “Fatal Control Error”
sys.exit(−1)

if not args.testsvm:

sys.exit(0)

if args.slicing !=0:

print “cannot use this svm code with slicing; exiting.”
sys.exit(0)

# Step 3: Try a k-fold cross-validation classification with an SVM in the simple set-up data

set case.

import ab_svm
(D,Y) = ab_svm.load_simpleone(args.output)
ab_svm.kfoldcv_svm(D,Y,10,cores=args.cores)

ab_svm.py—Code for using an svm classifier with an exemplary embodiment of the present invention. Include methods to (1) load the action bank vectors into a usable form (2) train a linear svm (using the shogun libraries) (3) do cross-validation

def detectCPUs( ):“““Detects the number of CPUs on a system.”””

# Linux, Unix and MacOS:
if hasattr(os, “sysconf”):

if os.sysconf_names.has_key(“SC_NPROCESSORS_ONLN”):

# Linux & Unix:
ncpus = os.sysconf(“SC_NPROCESSORS_ONLN”)
if isinstance(ncpus, int) and ncpus > 0:

return ncpus

else: # OSX:

return int(os.popen2(“sysct1 −n hw.ncpu”)[1].read( ))

# Windows:
if os.environ.has_key(“NUMBER_OF_PROCESSORS”):

ncpus = int(os.environ[“NUMBER_OF_PROCESSORS”]);
if ncpus > 0:

return ncpus

return 1 # Default

def kfoldcv_svm_aux(i,k,Dk,Yk,threads=1,useLibLinear=False,useL1R=False):

Di = Dk[0];
Yi = Yk[0];
for j in range(k):

if i==j:

continue

Di = np.vstack( (Di,Dk[j]) )
Yi = np.concatenate( (Yi,Yk[j]) )

Dt = Dk[i]
Yt = Yk[i]
# now we train on Di,Yi, and test on Dt,Yt. Be careful about how you set the threads (because

this is parallel already)
res=SVMLinear(Di,np.int32(Yi),Dt,threads=threads,useLibLinear=useLibLinear,useL1R=useL1
R)

tp=np.sum(res==Yt)
print ‘Accuracy is %.1f%%’% ((np.float64(tp)/Dt.shape[0])*100)
# examples of saving the results of the folds off to disk
#np.savez(‘/tmp/%02d.npz’ % (i),Yab=res,Ytrue=Yt)
#sio.savemat(‘/tmp/%02d.mat’ % (i),{‘Yab’:res,‘Ytrue’:np.int32(Yt)},oned_as=‘column’)

def kfoldcv_svm(D,Y,k,cores=1,innerCores=1,useLibLinear=False, useL1R=False):“‘Do k-fold cross-validation Folds are sampled by taking every kth item Does the k-fold CV with a fixed svm C constant set to 1.0.’”

Dk = [ ];
Yk = [ ];
for i in range(k):

Dk.append(D[i::k,:])
#Yk.append(np.squeeze(Y[i::k,:]))
Yk.append(Y[i::k])
#print i,Dk[i].shape, Yk[i].shape

if cores==1:

for j in range(1,k):

kfoldcv_svm_aux(j,k,Dk,Yk,innerCores,useLibLinear,useL1R)

else:

# for simplicity, we'll just throw away the first of the ten folds!
pool = multi.Pool(processes = min(k−1,cores))
for j in range(1,k):

pool.apply_async(kfoldcv_svm_aux,
(j,k,Dk,Yk,innerCores,useLibLinear,useL1R))

pool.close( )
pool.join( ) # forces us to wait until all of the pooled jobs are finished

def load_simpleone(root):“‘Code to load banked vectors at top-level directory root into a feature matrix and class-label vector. Classes are assumed to each exist in a single directory just under root. Example: root/jump, root/walk would have two classes “jump” and “walk” and in each root/X directory, there are a set of _banked.npy.gz files created by the actionbank.py script. For other more complex data set arrangements, you'd have to write some custom code, this is just an example. A feature matrix D and label vector Y are returned. Rows and D and Y correspond. You can use a script to save these as .mat files if you want to export to matlab . . . ’”

classdirs = os.listdir(root)
vlen=0 # length of each bank vector, we'll get it by loading one in...
Ds = [ ]
Ys = [ ]
for ci,c in enumerate(classdirs):

cd = os.path.join(root,c)
files = glob.glob(os.path.join(cd,‘*%s’%banked_suffix))
print “%d files in %s” %(len(files),cd)
if not vlen:

fp = gzip.open(files[0],“rb”)
vlen = len(np.load(fp))
fp.close( )
print “vector length is %d” % (vlen)

Di = np.zeros( (len(files),vlen), np.uint8)
Yi = np.ones ( (len(files) )) * ci
for bi,b in enumerate(files):

fp = gzip.open(b,“rb”)
Di[bi][:] = np.load(fp)
fp.close( )

Ds.append(Di)
Ys.append(Yi)

D = Ds[0]
Y = Ys[0]
for i,Di in enumerate(Ds[1:]):

D = np.vstack( (D,Di) )
Y = np.concatenate( (Y,Ys[i+1]) )

return D,Y

def wrapFeatures(data, sparse=False): “““This class wraps the given set of features in the appropriate shogun feature object. data=n by d array of features. sparse=if True, the features will be wrapped in a sparse feature object. returns: your data, wrapped in the appropriate feature type”””

if data.dtype == np.float64:

feats = LongRealFeatures(data.T)
featsout = SparseLongRealFeatures( )

if data.dtype == np.float32:

feats = RealFeatures(data.T)
featsout = SparseRealFeatures( )

elif data.dtype == np.int64:

feats = LongFeatures(data.T)
featsout = SparseLongFeatures( )

elif data.dtype == np.int32:

feats = IntFeatures(data.T)
featsout = SparseIntFeatures( )

elif data.dtype == np.int16 or data.dtype == np.int8:

feats = ShortFeatures(data.T)
featsout = SparseShortFeatures( )

elif data.dtype == np.byte or data.dtype == np.uint8:

feats = ByteFeatures(data.T)
featsout = SparseByteFeatures( )

elif data.dtype == np.bool8:

feats = BoolFeatures( )
featsout = SparseBoolFeatures( )

if sparse:

featsout.obtain_from_simple(feats)
return featsout

else:

return feats

defSVMLinear(traindata, trainlabs, testdata, C=1.0, eps=1e-5, threads=1, getw=False, useLibLinear=False,useL1R=False): “““Does efficient linear SVM using the OCAS subgradient solver. Handles multiclass problems using a one-versus-all approach. NOTE: the training and testing data may both be scaled such that each dimension ranges from 0 to 1. Traindata=n by d training data array. Trainlabs=n-length training data label vector (may be normalized so labels range from 0 to c-1, where c is the number of classes). Testdata=m by d array of data to test. C=SVM regularization constant. EPS=precision parameter used by OCAS. threads=number of threads to use. Getw=whether or not to return the learned weight vector from the SVM (note: this example only works for 2-class problems). Returns: m-length vector containing the predicted labels of the instances in testdata. If problem is 2-class and getw==True, then a d-length weight vector is also returned”””

numc = trainlabs.max( ) + 1
#### when using an L1 solver, we need the data transposed
#trainfeats = wrapFeatures(traindata, sparse=True)
#testfeats = wrapFeatures(testdata, sparse=True)
if not useL1R:

### traindata directly here for LR2_L2LOSS_SVC
trainfeats = wrapFeatures(traindata, sparse=False)

else:

### traindata.T here for L1R_LR
trainfeats = wrapFeatures(traindata.T, sparse=False)

testfeats = wrapFeatures(testdata, sparse=False)
if numc > 2:

preds = np.zeros(testdata.shape[0], dtype=np.int32)
predprobs = np.zeros(testdata.shape[0])
predprobs[:] = −np.inf
for i in xrange(numc):

#set up svm
tlabs = np.int32(trainlabs == i)
tlabs[tlabs==0] = −1
#print i,‘’, np.sum(tlabs==−1),‘’, np.sum(tlabs==1)
labels = Labels(np.float64(tlabs))
if useLibLinear:

#### Use LibLinear and set the solver type
svm = LibLinear(C, trainfeats, labels)
if useL1R:

# this is L1 regularization on logistic loss
svm.set_liblinear_solver_type(L1R_LR)

else:

# most of the results were computed with this (ucf50)
svm.set_liblinear_solver_type(L2R_L2LOSS_SVC)

else:

#### Or Use SVMOcas
svm = SVMOcas(C, trainfeats, labels)

svm.set_epsilon(eps)
svm.parallel.set_num_threads(threads)
svm.set_bias_enabled(True)
#train
svm.train( )
#test
res = svm.classify(testfeats).get_labels( )
thisclass = res > predprobs
preds[thisclass] = i
predprobs [thisclass] = res [thisclass]

return preds

else:

tlabs = trainlabs.copy( )
tlabs[tlabs == 0] = −1
labels = Labels(np.float64(tlabs))
svm = SVMOcas(C, trainfeats, labels)
svm.set_epsilon(eps)
svm.parallel.set_num_threads(threads)
svm.set_bias_enabled(True)
#train
svm.train( )
#test
res = svm.classify(testfeats).get_labels( )
res[res > 0] = 1
res[res <= 0] = 0
if getw == True:

return res, svm.get_w( )

else:

return res

spot.py—def imgInit3DG3(vid):

# Filters formulas
img=np.float32(vid.V)
SAMPLING_RATE = 0.5;
C=0.184
i = np.multiply(SAMPLING_RATE,range(−6,7,l))
f1 = −4*C*(2*(i**3)−3*i)*np.exp(−1*i**2)
f2 = i*np.exp(−1*i**2)
f3 = −4*C*(2*(i**2)−1)*np.exp(−1*i**2)
f4 = np.exp(−1*i**2)
f5 = −8*C*i*np.exp(−1*i**2)
filter_size=np.size(i)
# Convolving image with filters. Note the different filters along the different axes. X-axis

direction goes along the colums(this is how istare.video objects are stored.
(Frames,rows,Colums)) and hence axis=2. Similarly axis=1 for y direction and axis=0 for z
direction.

G3a_img = ndimage.convolve1d(img, f1,axis=2,mode=‘reflect’); # x-direction
G3a_img = ndimage.convolve1d(G3a_img,f4,axis=1,mode=‘reflect’); # y-direction
G3a_img = ndimage.convolve1d(G3a_img,f4,axis=0,mode=‘reflect’); # z-direction
G3b_img = ndimage.convolve1d(img, f3,axis=2,mode=‘reflect’); # x-direction
G3b_img = ndimage.convolve1d(G3b_img,f2,axis=1,mode=‘reflect’); # y-direction
G3b_img = ndimage.convolve1d(G3b_img,f4,axis=0,mode=‘reflect’); # z-direction
G3c_img = ndimage.convolve1d(img, f2,axis=2,mode=‘reflect’); # x-direction
G3c_img = ndimage.convolve1d(G3c_img,f3,axis=1,mode=‘reflect’); # y-direction
G3c_img = ndimage.convolve1d(G3c_img,f4,axis=0,mode=‘reflect’); # z-direction
G3d_img = ndimage.convolve1d(img, f4,axis=2,mode=‘reflect’); # x-direction
G3d_img = ndimage.convolve1d(G3d_img,f1,axis=1,mode=‘reflect’); # y-direction
G3d_img = ndimage.convolve1d(G3d_img,f4,axis=0,mode=‘reflect’); # z-direction
G3e_img = ndimage.convolve1d(img, f3,axis=2,mode=‘reflect’); # x-direction
G3e_img = ndimage.convolve1d(G3e_img,f4,axis=1,mode=‘reflect’); # y-direction
G3e_img = ndimage.convolve1d(G3e_img,f2,axis=0,mode=‘reflect’); # z-direction
G3f_img = ndimage.convolve1d(img, f5,axis=2,mode=‘reflect’); # x-direction
G3f_img = ndimage.convolve1d(G3f_img,f2,axis=1,mode=‘reflect’); # y-direction
G3f_img = ndimage.convolve1d(G3f_img,f2,axis=0,mode=‘reflect’); # z-direction
G3g_img = ndimage.convolve1d(img, f4,axis=2,mode=‘reflect’); # x-direction
G3g_img = ndimage.convolve1d(G3g_img,f3,axis=1,mode=‘reflect’); # y-direction
G3g_img = ndimage.convolve1d(G3g_img,f2,axis=0,mode=‘reflect’); # z-direction
G3h_img = ndimage.convolve1d(img, f2,axis=2,mode=‘reflect’); # x-direction
G3h_img = ndimage.convolve1d(G3h_img,f4,axis=1,mode=‘reflect’); # y-direction
G3h_img = ndimage.convolve1d(G3h_img,f3,axis=0,mode=‘reflect’); # z-direction
G3i_img = ndimage.convolve1d(img, f4,axis=2,mode=‘reflect’); # x-direction
G3i_img = ndimage.convolve1d(G3i_img,f2,axis=1,mode=‘reflect’); # y-direction
G3i_img = ndimage.convolve1d(G3i_img,f3,axis=0,mode=‘reflect’); # z-direction
G3j_img = ndimage.convolve1d(img, f4,axis=2,mode=‘reflect’); # x-direction
G3j_img = ndimage.convolve1d(G3j_img,f4,axis=1,mode=‘reflect’); # y-direction
G3j_img = ndimage.convolve1d(G3j_img,f1,axis=0,mode=‘reflect’); # z-direction
return (G3a_img, G3b_img, G3c_img, G3d_img, G3e_img, G3f_img, G3g_img,

G3h_img, G3i_img, G3j_img)

def imgSteer3DG3(direction, G3a_img, G3b_img, G3c_img, G3d_img, G3e_img, G3f_img, G3g_img, G3h_img, G3i_img, G3j_img):

a=direction[0]
b=direction[1]
c=direction[2]
# Linear Combination of the G3 basis filters.
img_G3_steer= G3a_img*a**3 \

+ G3b_img*3*a**2*b \
+ G3c_img*3*a*b**2 \
+ G3d_img*b**3 \
+ G3e_img*3*a**2*c \
+ G3f_img*6*a*b*c \
+ G3g_img*3*b**2*c \
+ G3h_img*3*a*c**2 \
+ G3i_img*3*b*c**2 \
+ G3j_img*c**3

return img_G3_steer

def calc_total_energy(nhat, e_axis, G3a_img, G3b_img, G3c_img, G3d_img, G3e_img, G3f_img, G3g_img, G3h_img, G3i_img, G3j_img):

# This is where the 4 directions in eq4 are calculated.
direction0= get_directions(n_hat,e_axis,0)
direction1= get_directions(n_hat,e_axis,1)
direction2= get_directions(n_hat,e_axis,2)
direction3= get_directions(n_hat,e_axis,3)
# Given the 4 directions, the energy along each of the 4 directions are found sepreately and

then added. This gives the total energy along one spatio-temporal direction.

#print ‘All directions done.. calculating energy along 1st direction’
energy1=

calc_directional_energy(direction0,G3a_img,G3b_img,G3c_img,G3d_img,G3e_img,G3f_img,G
3g_img,G3h_img,G3i_img,G3j_img)

#print‘Now along second direction’
energy2=

calc_directional_energy(direction1,G3a_img,G3b_img,G3c_img,G3d_img,G3e_img,G3f_img,G
3g_img,G3h_img,G3i_img,G3j_img)

#print ‘Now along third direction’
energy3=

calc_directional_energy(direction2,G3a_img,G3b_img,G3c_img,G3d_img,G3e_img,G3f_img,G
3g_img,G3h_img,G3i_img,G3j_img)

#print ‘Now along fourth direction’
energy4=

calc_directional_energy(directions,G3a_img,G3b_img,G3c_img,G3d_img,G3e_img,G3f_img,G
3g_img,G3h_img,G3i_img,G3j_img)

total_energy= energy1+energy2+energy3+energy4
#print ‘Total energy calculated’
return total_energy

def calc_directional_energy(direction, G3a_img, G3b_img, G3c_img, G3d_img, G3e_img, G3f_img, G3g_img, G3h_img, G3i_img, G3j_img):

G3_steered= imgSteer3DG3(direction, G3a_img, G3b_img,
G3c_img, G3d_img,

G3e_img, G3f_img, G3g_img, G3h_img, G3i_img, G3j_img)

unnormalised_energy= G3_steered**2
return unnormalised_energy

def get_directions(n_hat,e_axis,i):

n_cross_e=np.cross(n_hat,e_axis)
theta_na=n_cross_e/mag_vect(n_cross_e)
theta_nb= np.cross(n_hat,theta_na)
theta_i= np.cos((np.pi*i)/(4))*theta_na + np.sin((np.pi*i)/4)*theta_nb
# Gettin theta Eq3
orthogonal_direction= np.cross(n_hat,theta_i) # Angle in spatial domain
orthogonal_magnitude= mag_vect(orthogonal_direction) # Its magnitude
mag_theta=mag_vect(theta_i)
alpha=theta_i[0]/mag_theta
beta=theta_i[1]/mag_theta
gamma=theta_i[2]/mag_theta
return ([alpha,beta,gamma])

def mag_vect(a):

mag=np.sqrt(a[0]**2 + a[1]**2 + a[2]**2)
return mag

def calc_spatio_temporal_energies(vid): “‘This function returns a 7 Feature per pixel video corresponding to 7 energies oriented towards the left, right, up, down, flicker, static and ‘lack of structure’ spatio-temporal energies. Returned as a list of seven grayscale-videos’”

ts=t.time( )
#print ‘Generating G3 basis Filters.. Function definition in G3H3_helpers.py’
(G3a_img, G3b_img ,G3c_img, G3d_img, G3e_img, G3f_img, G3g_img, G3h_img,

G3i_img, G3j_img) = imgInit3DG3(vid)

| #‘Unit normals for each spatio-temporal direction. Used in eq 3 of paper’ | |
|---|---|
| root2 = 1.41421356 | |
| leftn_hat = ([−1/root2, 0, 1/root2]) | |
| rightn_hat = | ([1/root2, 0, 1/root2]) |
| downn_hat = | ([0, 1/root2,1/root2]) |
| upn_hat = | ([0, −1/root2,1/root2]) |
| flickern_hat = | ([0, 0, 1 ]) |
| staticn_hat = | ([1/root2, 1/root2,0 ]) |

e_axis = ([0,1,0])
sigmag=1.0
#print(‘Calculating Left Oriented Energy’)
energy_left=

calc_total_energy(leftn_hat,e_axis,G3a_img,G3b_img,G3c_img,G3d_img,G3e_img,G3f_img,G
3g_img,G3h_img,G3i_img,G3j_img)

energy_left=ndimage.gaussian_filter(energy_left,sigma=sigmag)
#print(‘Calculating Right Oriented Energy’)
energy_right=

calc_total_energy(rightn_hat,e_axis,G3a_img,G3b_img,G3c_img,G3d_img,G3e_img,G3f_img,
G3g_img,G3h_img,G3i_img,G3j_img)

energy_right=ndimage.gaussian_filter(energy_right,sigma=sigmag)
#print(‘Calculating Up Oriented Energy’)
energy_up=

calc_total_energy(upn_hat,e_axis,G3a_img,G3b_img,G3c_img,G3d_img,G3e_img,G3f_img,G3
g_img,G3h_img,G3i_img,G3j_img)

energy_up=ndimage.gaussian_filter(energy_up,sigma=sigmag)
#print(‘Calculating Down Oriented Energy’)
energy_down=

calc_total_energy(downn_hat,e_axis,G3a_img,G3b_img,G3c_img,G3d_img,G3e_img,G3f_img,
G3g_img,G3h_img,G3i_img,G3j_img)

energy_down=ndimage.gaussian_filter(energy_down,sigma=sigmag)
#print(‘Calculating Static Oriented Energy’)
energy_static=

calc_total_energy(staticn_hat,e_axis,G3a_img,G3b_img,G3c_img,G3d_img,G3e_img,G3f_img,
G3g_img,G3h_img,G3i_img,G3j_img)

energy_static=ndimage.gaussian_filter(energy_static,sigma=sigmag)
#print(‘Calculating Flicker Oriented Energy’)
energy_flicker=

calc_total_energy(flickern_hat,e_axis,G3a_img,G3b_img,G3c_img,G3d_img,G3e_img,G3f_img
,G3g_img,G3h_img,G3i_img,G3j_img)

energy_flicker=ndimage.gaussian_filter(energy_flicker,sigma=sigmag)
#print ‘Normalising Energies’

c=np.max([np.mean(energy_left),np.mean(energy_right),np.mean(energy_up),np.mean(energy_{—}
down),np.mean(energy_static),np.mean(energy_flicker)])*1/100

#print (“normalize with c %d” %c)
# norm_energy is the sum of the consort planar energies, c is the epsillon value in eq5
norm_energy = energy_left + energy_right + energy_up + energy_down + energy_static +

energy_flicker + c

| # Normalisation with consort planar energy | |
|---|---|
| vid_left_out | = video.asvideo( energy_left / (norm_energy )) |
| vid_right_out | = video.asvideo( energy_right / (norm_energy )) |

| | |
|---|---|
| vid_up_out | = video.asvideo( energy_up / ( norm_energy )) |

| | |
|---|---|
| vid_down_out | = video.asvideo( energy_down / (norm_energy )) |

| vid_static_out = video.asvideo( energy_flicker / (norm_energy )) | |
|---|---|
| vid_flicker_out = video.asvideo( energy_static / (norm_energy)) | |
| vid_structure_out= video.asvideo( c | / ( norm_energy )) |

#print ‘Done’
te=t.time( )
print str((te-ts)) + ‘ Seconds to execution (calculating energies)’
return vid_left_out \

,vid_right_out \
,vid_up_out \
,vid_down_out \
,vid_static_out \
,vid_flicker_out \
,vid_structure_out

def resample_with_gaussian_blur(input_array, sigma_for_gaussian, resampling_factor):

sz=input_array.shape
gauss_temp=ndimage.gaussian_filter(input_array,sigma=sigma_for_gaussian)
resam_temp=sg.resample(gauss_temp,axis=1,num=sz[1]/resampling_factor)
resam_temp=sg.resample(resam_temp,axis=2,num=sz[2]/resampling_factor)
return (resam_temp)

def resample_without_gaussian_blur(input_army,resampling_factor):

sz=input_array.shape
resam_temp=sg.resample(input_array,axis=1,num=sz[1]/resampling_factor)
resam_temp=sg.resample(resam_temp,axis=2,num=sz[2]/resampling_factor)
return (resam_temp)

def linclamp(A):

A[A<0.0] = 0.0
A[A>1.0] = 1.0
return A

def linstretch(A):

min_res=A.min( )
max_res=A.max( )
return (A−min_res)/(max_res−min_res)

def call_resample_with_{—}7D(input_array,factor):

sz=input_array.shape
temp_output=np.zeros((sz[0],sz[1]/factor,sz[2]/factor,7),dtype=np.float32)
for i in range(7):

temp_output[:,:,:,i]=resample_with_gaussian_blur(input_array[:,:,:,i],1.25,factor)

return linstretch(temp_output)

def featurize_video(vid_in,factor=1,maxcols=None,lock=None): “‘Takes a video, converts it into its 5 dim of “pure” oriented energy. We found the extra two dimensions (static and lack of structure) to decrease performance and sharpen the other 5 motion energies when used to remove “background.” Input: vid_in may be a numpy video array or a path to a video file Lock is a multiprocessing Lock that is needed if this is being called from multiple threads.’”

# Converting video to video object (if needed)
svid_obj=None
if type(vid_in) is video.Video:

svid_obj = vid_in

else:

svid_obj=video.asvideo(vid_in,factor,maxcols=maxcols,lock=lock)

if svid_obj.V.shape[3] > 1:

svid_obj=svid_obj.rgb2gray( )

# Calculating and storing the 7D feature videos for the search video

left_search,right_search,up_search,down_search,static_search,flicker_search,los_search=calc_sp
atio_temporal_energies(svid_obj)

# Compressing all search feature videos to a single 7D array.

search_final=compress_to_7D(left_search,right_search,up_search,down_search,static_search,flic
ker_search,los_search,7)

#do not force a downsampling.
#res_search_final=call_resample_with_7D(search_final)
# Taking away static and structure features and normalising again
fin = normalize(takeaway(linstretch(search_final)))
return fin

def match_bhatt(T,A): ‘“Implements the Bhattacharyya Coefficient Matching via FFT Forces a full correlation first and then extracts the center portion of the convolution. Our bhatt correlation, that assumes the static and lack of structure channels (4 and 6) have already been subtracted out.’”

szT = T.shape
szA = A.shape
#szOut = [szA[0],szA[1],szA[2]]
szOut = [szA[0]+szT[0],szA[1]+szT[1],szA[2]+szT[2]]
Tsqrt = T**0.5
T[np.isnan(T)] = 0
T[np.isinf(T)] = 0
Asqrt = A**0.5
M = np.zeros(szOut,dtype=np.float32)
if not conf_useFFTW:

for i in [0,1,2,3,5]:

rotTsqrt = np.squeeze(Tsqrt[::−1,::−1,::−1,i])
Tf = fftn(rotTsqrt,szOut)
Af = fftn(np.squeeze(Asqrt[:,:,:,i]),szOut)
M = M + Tf*Af

#M = ifftn(M).real / np.prod([szT[0],szT[1],szT[2]])
# normalize by the number of nonzero locations in the template
rather than
# total number of location in the template
temp = np.sum((T.sum(axis=3)>0.00001).flatten( ))
#print(np.prod([szT[0],szT[1],szT[2]]),temp)
M = ifftn(M).real / temp

else:

# use the FFTW library through anfft.
# This library does not automatically zero-pad, so we have to do
that manually
for i in [0,1,2,3,5]:

rotTsqrt = np.squeeze(Tsqrt[::−1,::−1,::−1,i])
TfZ = np.zeros(szOut)
AfZ = np.zeros(szOut)
TfZ[0:szT[0],0:szT[1],0:szT[2]] = rotTsqrt
AfZ[0:szA[0],0:szA[1],0:szA[2]] = np.squeeze(Asqrt[:,:,:,i])
Tf = anfft.fftn(TfZ,3,measure=True)
Af = anfft.fftn(AfZ,3,measure=True)
M = M + Tf*Af

temp = np.sum( (T.sum(axis=3)>0.00001).flatten( ) )
M = anfft.ifftn(M).real / temp

return M[szT[0]/2:szA[0]+szT[0]/2, \

```
  szT[1]/2:szA[1]+szT[1]/2, \
  szT[2]/2:szA[2]+szT[2]/2]
```

def match_bhatt_weighted(T,A): “‘Implements the Bhattacharyya Coefficient Matching via FFT. Forces a full correlation first and then extracts the center portion of the convolution. Raw Spotting bhatt correlation (uses weighting on the static and lack of structure channels).’”

szT = T.shape
szA = A.shape
#szOut = [szA[0],szA[1],szA[2]]
szOut = [szA[0]+szT[0],szA[1]+szT[1],szA[2]+szT[2]]
W =1 − T[:,:,:,6] − T[:,:,:,4]
# apply the weight matrix to the template after the sqrt op.
T = T**0.5
Tsqrt = T*W.reshape([szT[0],szT[1],szT[2],1])
Asqrt = A**0.5
M = np.zeros(szOut,dtype=np.float32)
for i in range(7):

rotTsqrt = np.squeeze(Tsqrt[::−1,::−1,::−1,i])
Tf = fftn(rotTsqrt,szOut)
Af = fftn(np.squeeze(Asqrt[:,:,:,i]),szOut)
M = M + Tf*Af

#M = ifftn(M).real / np.prod([szT[0],szT[1],szT[2]])
# normalize by the number of nonzero locations in the template rather
than
# total number of location in the template
temp = np.sum( (T.sum(axis=3)>0.00001).flatten( ))
#print (np.prod([szT[0],szT[1],szT[2]]),temp)
M = ifftn(M).real / temp
return M[szT[0]/2:szA[0]+szT[0]/2, \

szT[1]/2:szA[1]+szT[1]/2, \
szT[2]/2:szA[2]+szT[2]/2]

def match_ncc(T,A):“‘Implements normalized cross-correlation of the template to the search video A. Will do weighting of the template inside here.’”

szT = T.shape
szA = A. shape
# leave this in here if you want to weight the template
W = 1 − T[:,:,:,6] − T[:,:,:,4]
T = T*W.reshape([szT[0],szT[1],szT[2],1])
split(video.asvideo(T)).display( )
M = np.zeros([szA[0],szA[1],szA[2]],dtype=np.float32)
for i in range(7):

if i==4 or i==6:

continue

t = np.squeeze(T[:,:,:,i])
# need to zero-mean the template per the normxcorr3d function
below
t = t − t.mean( )
M = M + normxcorr3d(t,np.squeeze(A[:,:,:,i]))

M = M/5
return M

def normxcorr3d(T,A):

szT = np.array(T.shape)
szA = np.array(A.shape)
if (szT.any( )>szA.any( )):

print ‘Template must be smaller than the Search video’
sys.exit(0)

pSzT = np.prod(szT)
intImgA=integralImage(A,szT)
intImgA2=integralImage(A*A,szT)
szOut = intImgA[:,:,:].shape
rotT = T[::−1,::−1,::−1]
fftRotT = fftn(rotT,s=szOut)
fftA = fftn(A,s=szOut)
corrTA = ifftn(fftA*fftRotT).real
# Numerator calculation
num = (corrTA − intImgA*np.sum(T.flatten( ))/pSzT)/(pSzT−1)
# Denominator calculaton
denomA = np.sqrt((intImgA2 − (intImgA**2)/pSzT)/(pSzT−1))
denomT = np.std(T.flatten( ))
denom=denomT*denomA
C=num/denom
nanpos=np.isnan(C)
C[nanpos]=0
return C[szT[0]/2:szA[0]+szT[0]/2, \
szT[1]/2:szA[1]+szT[1]/2, \
szT[2]/2:szA[2]+szT[2]/2]

def integralImage(A,szT):\

szA = np.array(A.shape) #A is just a 3d matrix here. 1 Feature video
B=np.zeros(szA+2*szT−1,dtype=np.float32)
B[szT[0]:szT[0]+szA[0],szT[1]:szT[1]+szA[1],szT[2]:szT[2]+szA[2]]=A
s=np.cumsum(B,0)
c=s[szT[0]:,:,:]−s[:−szT[0],:,:]
s=np.cumsum(c,l)
c=s[:,szT[1]:,:]−s[:,:−szT[1],:]
s=np.cumsum(c,2)
integralImageA=s[:,:,szT[2]:]−s[:,:,:−szT[2]]
return integralImageA

def compress_to_{—}7D(*args):“‘This function takes those 7 feature istare.video objects and an argument mentioning the first ‘n’ arguments to be considered for the compression to a single [:,:,:,n] dim video’”

ret_array=np.zeros([args[0].V.shape[0],args[0].V.shape[1],args[0].V.shape[2],args[−

1]],dtype=np.float32)

for i in range(0,args[−1]):

ret_array[:,:,:,i]=args[i].V.squeeze( )

return ret_array

def normalize(V):“‘Takes arguments of ndarray and normalizes along the 4th dim.’”

Z = V / (V.sum(axis=3))[:,:,:,np.newaxis]
Z[np.isnan(Z)] = 0
Z[np.isinf(Z)] = 0
return Z

def pretty(*args): “‘Takes the argument videos, assumes they are all the same size, and drops them into one monster video, row-wise.’”

n = len(args)
if type(args[0]) is video.Video:

sz = np.asarray(args[0].V.shape)

else: # assumed it is a numpy.ndarray

sz = np.asarray(args[0].shape)

w = sz[2]
sz[2] *= n
A = np.zeros(sz,dtype=np.float32)
if type(args[0]) is video.Video:

for i in np.arange(n):

A[:,:,i*w:(i+1)*w,:] = args[i].V

else: #assumed it is a numpy.ndarray

for i in np.arange(n):

A[:,:,i*w:(i+1)*w,:] = args[i]

return video.asvideo(A)

def split(V):“split a N-band image into a 1-band image side-by-side, like pretty’”

| sz = np.asarray(V.shape) | |
|---|---|
| n | = sz[3] |
| sz[3] = 1 | |
| w | = sz[2] |

sz[2] *= n
A = np.zeros(sz,dtype=np.float32)
for i in np.arange(n):

A[:,:,i*w:(i+1)*w,0] = V[:,:,:,i]

return video.asvideo(A)

def ret_{—}7D_video_objs(V):

return [(video.asvideo(V[:,:,:,0]), video.asvideo(V[:,:,:,0]),
video.asvideo(V[:,:,:,0]),

video.asvideo(V[:,:,:,0]), video.asvideo(V[:,:,:,0]),
video.asvideo(V[:,:,:,0]),
video.asvideo(V[:,:,:,0]), video.asvideo(V[:,:,:,0]))]

def takeaway(V): “‘subtracts all energy from channels static and los clamps at 0 at the bottom V is an ndarray with 7-bands’”

A = np.zeros(V.shape,dtype=np.float32)
for i in range(7):

a = V[:,:,:,i] − V[:,:,:,4] − V[:,:,:,6]
a[a<0] = 0
A[:,:,:,i] = a

return A

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of recognizing activity in a video object using an action bank containing a set of template objects, each template object corresponding to an action and having a template sub-vector, the method comprising the steps of:
processing the video object to obtain a featurized video object;
calculating a vector corresponding to the featurized video object;
correlating the featurized video object vector with each template object sub-vector to obtain a correlation vector;
computing the correlation vectors into a correlation volume; and
determining one or more maximum values corresponding to one or more actions of the action bank to recognize activity in the video object.

2. The method of claim 1, further comprising the step of dividing the video object into video segments, wherein the step of calculating a vector corresponding to the video object is based on the video segments.

3. The method of claim 1, wherein the correlation of the featurized video object with each template object sub-vector is performed at multiple scales and the one or more maximum values are determined at multiple scales.

4. The method claim 1, wherein the step of determining one or more maximum values corresponding to one or more actions of the action bank to recognize activity in the video object comprises the sub step of applying a support vector machine to the one or more maximum values.

5. The method of claim 1, wherein the activity is recognized at a time and space within the video object.

6. The method of claim 2, wherein the sub-vector has an energy volume.

7. The method of claim 6, wherein the video object has an energy volume, and the method further comprises the step of correlating the template object sub-vector energy volume to the video object energy volume.

8. The method of claim 7, further comprising the step of calculating an energy volume of the video object, the calculation step comprising the sub-steps of:
calculating a first structure volume corresponding to static elements in the video object;
calculating a second structure volume corresponding to a lack of oriented structure in the video object;
calculating at least one directional volume of the video object;
subtracting the first structure volume and the second structure volume from the directional volumes.
